(19) United States
(12) Patent Application Publication
(10) Pub. No.: US 2010/0293255 A1
(43) Pub. Date: Nov. 18, 2010

(54) OPEN INFORMATION TRANSMITTING METHOD, OPEN INFORMATION TRANSMITTING SYSTEM, CENTRAL DEVICE AND RECORDING MEDIUM

(75) Inventors: Masahiro HARA, Kawasaki (JP); Masayuki Fukui, Kawasaki (JP); Tatsuro Matsumoto, Kawasaki (JP); Takao Mohri, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/845,285

(22) Filed: Jul. 28, 2010

Related U.S. Application Data
(63) Continuation of application No. PCT/JP2008/051477, filed on Jan. 31, 2008.

(51) Int. Cl. G06F 15/16

(52) U.S. Cl. 709/219

(57) ABSTRACT

In an open information transmitting method transmitting open information, transmitted from a mobile information terminal to a central device so as to be released to a third party, from the central device to an information processing terminal, the central device including a processor receives positional information transmitted from the mobile information terminal; the processor converts a word indicating a location included in the open information transmitted from the mobile information terminal into a word indicating a location belonging to a higher class, with reference to a location database in which words indicating locations are classified in accordance with a plurality of classes; and the processor transmits the converted open information from the central device to the information processing terminal.

### CROSS-REFERENCE TO RELATED APPLICATIONS

This application is the continuation, filed under 35 U.S.C. §111(a), of PCT International Application No. PCT/JP2008/051477 which has an International filing date of Jan. 31, 2008 and designated the United States of America.

### FIELD

The present invention relates to an open information transmitting method of transmitting open information, transmitted from a mobile information terminal to a central device so as to be released to a third party, from the central device to an information processing terminal.

### BACKGROUND

In recent years, so-called a blog, in which a diary, a photograph and the like of a user are uploaded and released to a third party, has become widespread on the Internet. In addition to blogs, services offering communication fields by human networks on the basis of the relationship of mutual trust between users have also been widely used. Such a service is called a social network service (hereinafter referred to as SNS). Various kinds of enterprises offer a wide variety of SNS. In SNS, unlike a general web page or a blog, a range in which information such as a profile, a diary and a photograph of the user is released to public may be designated.

For instance, the range of releasing information to public may be designated such that the information may be released to a friend of the user, or to a friend of a friend of the user. By thus designating the releasing range, communication between predetermined users may be established. Using a blog or SNS, the user may freely release information on his/her activities almost in real time to a third party. This allows the third party to casually obtain more recent information (see, for example, Japanese Patent Application Laid-Open No. 2006-4318).

### SUMMARY

In an open information transmitting method transmitting open information, transmitted from a mobile information terminal to a central device so as to be released to a third party, from the central device to an information processing terminal, the central device including a processor receives positional information transmitted from the mobile information terminal; the processor converts a word indicating a location included in the open information transmitted from the mobile information terminal into a word indicating a location belonging to a higher class, with reference to a location database in which words indicating locations are classified in accordance with a plurality of classes; and the processor transmits the converted open information from the central device to the information processing terminal when a distance between positions based on the received positional information of the mobile information terminal and positional information of the mobile information terminal obtained when the open information is transmitted is equal to or more than a threshold distance stored in a storage unit.

The object and advantages of the invention will be realized and attained by the elements and combinations particularly pointed out in the claims. It is to be understood that both the foregoing general description and the following detailed description are exemplary and explanatory and are not restrictive of the embodiment, as claimed.

### BRIEF DESCRIPTION OF THE DRAWINGS

FIG. 1 is a schematic diagram illustrating the outline of an open information transmitting system.

FIG. 2 is a block diagram illustrating hardware of a mobile telephone.

FIG. 3 is a block diagram illustrating hardware of a server computer.

FIG. 4 is an explanatory view illustrating an image obtained when open information is registered.

FIG. 5 is an explanatory view illustrating a record layout of a date-and-time storing file.

FIG. 6 is an explanatory view illustrating a record layout of a position storing file.

FIG. 7 is an explanatory view illustrating a record layout of a location DB.

FIG. 8 is an explanatory view illustrating a record layout of a time DB.

FIG. 9 is an explanatory view illustrating a record layout of an identification information file.

FIGS. 10A and 10B are explanatory views illustrating display images of open information.

FIGS. 11A to 11C depict a flowchart illustrating the procedure of the process of registering and converting open information.

FIGS. 12A and 12B depict a flowchart illustrating the procedure used when open information is transmitted.

FIG. 13 is an explanatory view illustrating an image obtained when open information is registered according to Embodiment 2.

FIG. 14 is an explanatory view illustrating a record layout of a date-and-time storing file according to Embodiment 2.

FIGS. 15A and 15B depict a flowchart illustrating the processing procedure used when a threshold distance is determined.

FIGS. 16A and 16B depict a flowchart illustrating the processing procedure used when a threshold time is determined.

FIG. 17 is an explanatory view illustrating a record layout of a location DB.

FIG. 18 is an explanatory view illustrating a record layout of a time DB.

FIGS. 19A and 19B are explanatory views illustrating display images of open information.

FIG. 20 is a flowchart illustrating the procedure of converting and threshold-distance-increasing processes performed when a demonstrative pronoun is included.

FIG. 21 is a flowchart illustrating the procedure of converting and threshold-time-increasing process performed when a word indicating past, present or future is included.

FIG. 22 is a block diagram illustrating hardware of a server computer according to Embodiment 4.

FIGS. 23A and 23B depict a flowchart illustrating the procedure of a shortening process.

FIG. 24 is an explanatory view illustrating a record layout of a position storing file according to Embodiment 2.

FIG. 25 is a flowchart illustrating the procedure of an increasing process.

FIG. 26 is an explanatory view illustrating the record layout of a position storing file according to Embodiment 6.

FIGS. 27A and 27B depict a flow chart illustrating the procedure of a shortening process for threshold time and a threshold distance based on moving speed.

FIGS. 28A and 28B are explanatory views illustrating display images of open information.

FIGS. 29A and 29B depict a flow chart illustrating the procedure of a converting process.

FIGS. 30A and 30B are graphic charts for explaining processing contents of Embodiment 8.

FIGS. 31A and 31B are explanatory views illustrating display images of open information.

FIGS. 32A to C depict a flowchart illustrating the procedures of a converting process and a transmitting process.

FIG. 33 is a block diagram illustrating hardware of a server computer according to Embodiment 9.

### DESCRIPTION OF EMBODIMENTS

### Embodiment 1

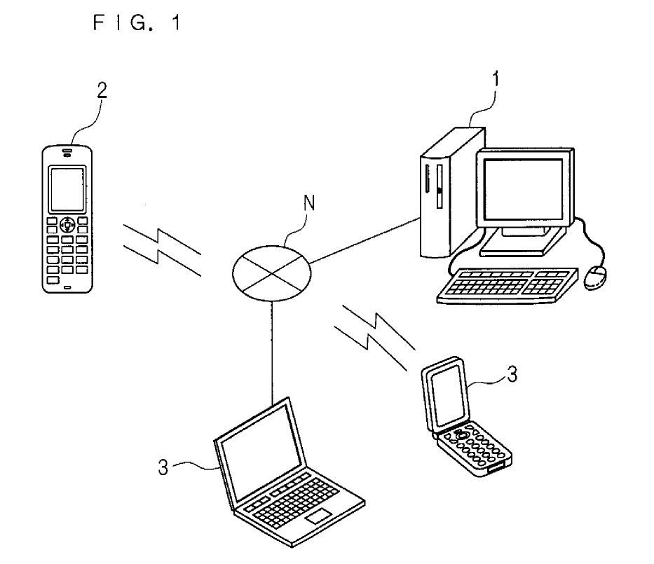

An embodiment will be described below with reference to the drawings. FIG. 1 is a schematic diagram illustrating the outline of an open information transmitting system. The open information transmitting system includes a central device 1, a mobile information terminal 2, a communication network N and information processing terminals 3, 3, . . . . Examples of the mobile information terminal 2 include a mobile telephone, a Personal Digital Assistance (PDA), a notebook computer, a portable audio player with a display unit and an input unit, a digital camera with a communication function, a portable game machine or the like, which are used by the user who uploads open information to a blog or SNS. The mobile information terminal 2 is described below as a mobile phone 2. Moreover, an example in which information is uploaded to SNS is used for explanation.

The central device 1 may be, for example, a server computer, while the information processing terminal 3 may be a mobile phone, a personal computer 3 or the like. In the description below, the central device 1 is described as a server computer 1, whereas the information processing terminal 3 is described as a personal computer 3. The mobile phone 2, the server computer 1 and the personal computer 3 are connected with one another via the communication network N such as a mobile telephone network and the Internet. The mobile phone 2, the server computer 1 and the personal computer 3 transmits and receives, for example, an Hyper Text Markup Language (HTML) document by the Hyper Text Transfer Protocol (HTTP).

The user transmits open information, which is to be released to a third party, to the server computer 1 using the mobile phone 2. The server computer 1 observes a present position of the mobile phone 2 and the time elapsed from the transmission of the open information. The server computer 1 judges whether or not the mobile phone 2 is a given distance away from the position at which the open information is transmitted and given time has elapsed from the time when the open information is transmitted. If the server computer 1 determines that the mobile phone 2 is a given distance away and given time has elapsed, words indicating a location and time of the open information are made unspecific. The server computer 1 transmits the open information, on which the unspecifying process has been performed, to the personal computer 3.

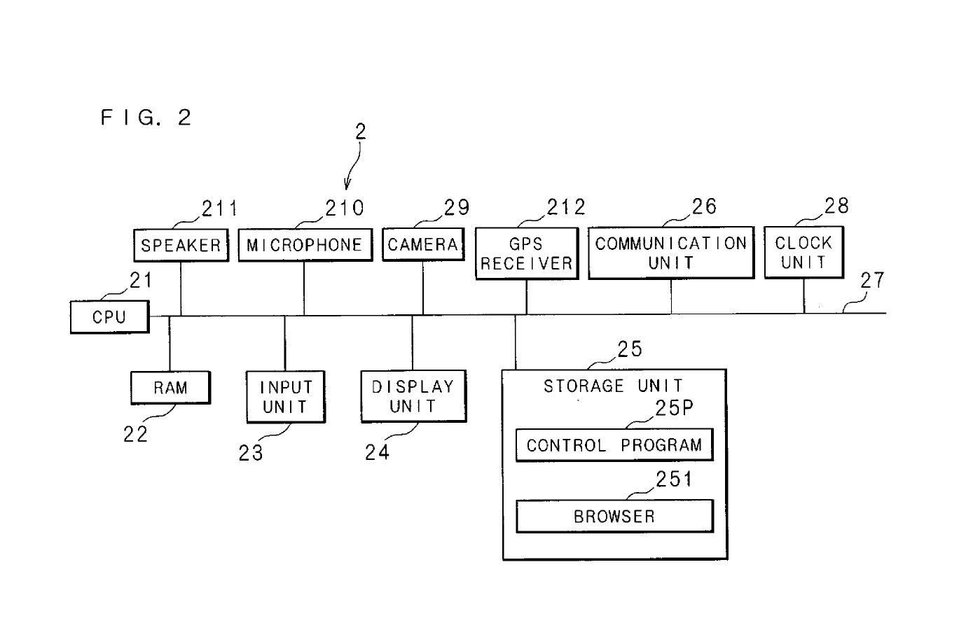

FIG. 2 is a block diagram illustrating hardware of the mobile phone 2. The mobile phone 2 includes a Central Processing Unit (CPU) 21 as a control unit, a Random Access Memory (RAM) 22, an input unit 23, a display unit 24, a storage unit 25, a communication unit 26, a clock unit 28, a Global Positioning System (GPS) receiver 212, a camera 29, a microphone 210, a loudspeaker 211 and the like. The CPU 21 is connected to each hardware device of the mobile phone 2 via a bus 27. The CPU 21 controls hardware while executing various software functions in accordance with a control program 25P stored in the storage unit 25.

The display unit 24 may be a liquid crystal display or the like for example, whereas the input unit 23 may be a push button or the like. A touch panel may also be employed. The loudspeaker 211 amplifies and outputs a voice signal concerning voice data, call data or voice input from the microphone 210. The microphone 210 converts the externally input voice signal into an electric signal. The converted electric signal is converted into digital data by an A/D converter (not illustrated) and output to the CPU 21. The communication unit 26 includes, for example, a high-frequency transmission/reception unit and an antenna. The communication unit 26 performs transmission and reception of various kinds of data including voice data, text data, image data and the like. The clock unit 28 outputs information on the present date and time to the CPU 21.

The storage unit 25 stores therein the control program 25P, a browser 251 and the like. The browser 251 analyses an HTML file transmitted/received by HTTP via the communication unit 26 and displays the result on the display unit 24. The camera 29 may be a Charge Coupled Device (CCD) or the like, outputting taken image data to the CPU 21. The GPS receiver 212 receives electric wave from an artificial satellite (GPS satellite) to determine the present position (including latitude, longitude and altitude) and the present orientation of the mobile phone 2. The CPU 21 transmits the positional information received by the GPS receiver 212, more specifically, the latitude and the longitude, to the server computer 1 for every certain time period (e.g., every ten minutes).

Though the present embodiment describes a pattern where the GPS receiver 212 is used for the method of acquiring the positional information of the mobile phone 2, it is not limited thereto as long as positional information may be acquired at regular intervals. For example, the information on an access point of wireless Local Area Network (LAN), the positional information of a base station of the mobile phone 2, the positional information of a reader which reads a wireless tag built into the mobile phone 2 may also be utilized.

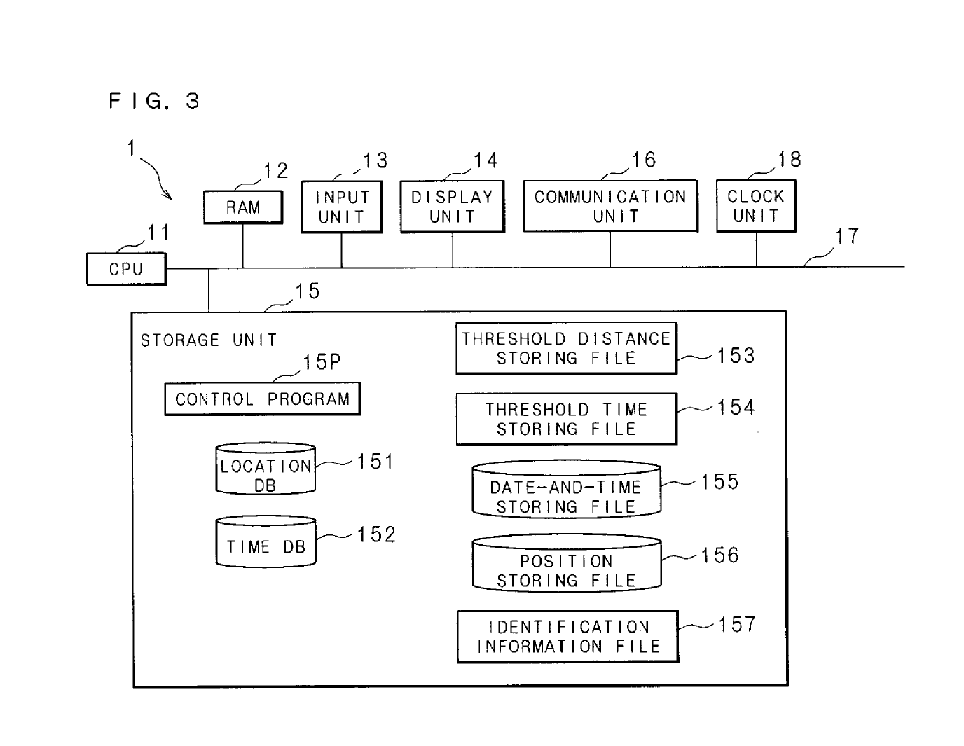

FIG. 3 is a block diagram illustrating hardware of the server computer 1. The server computer 1 includes, for example, a CPU 11 as a control unit, a RAM 12, an input unit 13, a display unit 14, a communication unit 16, a clock unit 18 and a storage unit 15. The CPU 11 is connected to each hardware unit of the server computer 1 via a bus 17. The CPU 11 controls hardware while executing various software functions in accordance with the control program 15P stored in the storage unit 15. The display unit 14 is, for example, a liquid crystal display, which displays necessary information thereon. The input unit 13 includes a keyboard, a mouse and the like. The information input from the input unit 13 is output to the CPU 11. The clock unit 18 outputs the information on the present date and time to the CPU 11.

The communication unit 16 is, for example, a gateway serving as a firewall, which transmits and receives necessary information between the communication unit 16 and the mobile phone 2. The storage unit 15 is, for example, a hard disk. The storage unit 15 stores therein, in addition to the control program 15P described above, a location database (hereinafter referred to as DB) 151, a time DB 152, a threshold distance storing file 153, a threshold time storing file 154, a date-and-time storing file 155, a position storing file 156 and an identification information file 157. These DBs and files may be stored in the storage unit 15 of the server computer 1, or alternatively be stored in a DB server (not illustrated) where detection and writing processes of necessary information are executed using Structured Query Language (SQL). Each of the DBs and files will be described later in detail.

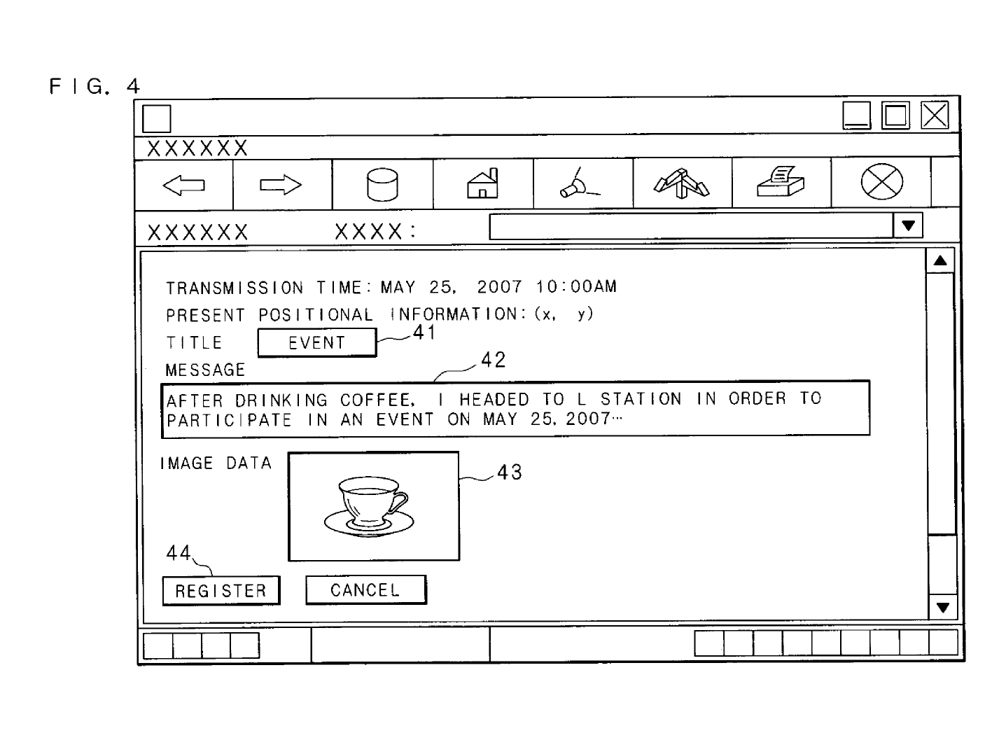

FIG. 4 is an explanatory view illustrating an image obtained when open information is registered. When the mobile phone 2 accesses the server computer 1, the CPU 11 in the server computer 1 reads out a template of an open information registering screen stored in the storage unit 15 and transmits it to the mobile phone 2. The CPU 21 of the mobile phone 2 boots up the browser 251 and displays the open information registering screen as illustrated in FIG. 4. The open information is information to be released to a third party by the user of the mobile phone 2, including a title, a message, image data, a linked Uniform Resource Locator (URL) and the like.

On the open information registering screen on the browser 251, a title box 41, a message box 42, an image data thumbnail 43, a register button 44 and the like are displayed. The user inputs open information in the title box 41 and the message box 42 through the input unit 23. In the example of FIG. 4, text data “event” is input in the title box 41 from the input unit 23 and displayed on the browser 251. Moreover, in the message box 42, text data including “After drinking coffee, I headed to L station in order to participate in an event on May 25, 2007. . . . ” is input from the input unit 23 and displayed on the browser 251.

The CPU 21 also displays information concerning the present date and time on the open information registering screen of the browser 251 based on the date-and-time information output from the clock unit 28. In the example of FIG. 4, the present date and time are displayed as “May 25, 2007, 10:00:00 AM.” The CPU 21 further displays the latitude and longitude on the open information registering screen of the browser 251 as the present positional information based on the output of the GPS receiver 212. Note that the latitude is x while the longitude is y in the example of FIG. 4. In the image data thumbnail 43, a thumbnail of image data to be released in SNS along with a message is displayed. The CPU 21 stores image data taken through the camera 29 in the storage unit 25. The CPU 21 generates a thumbnail image of the image data stored in the storage unit 25, and displays the generated image data thumbnail 43 on the open information registering screen of the browser 251.

When the user desires to register the input content, he/she clicks the register button 44 via the input unit 23. The CPU 21 transmits the input title, message, image data, present date and time (transmission date and time) and present positional information to the server computer 1 along with identification information uniquely given to each user. In the present example, the user of the mobile phone 2 is referred to as a user S for purpose of explanation.

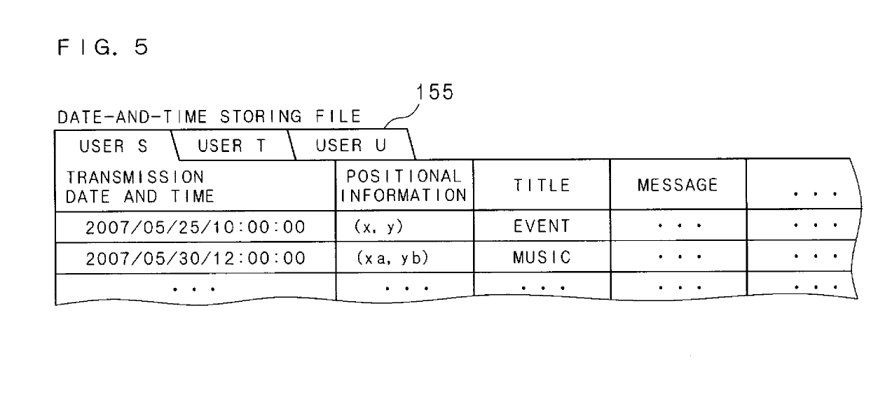

The CPU 11 in the server computer 1 receives the transmitted title, message, image data, date-and-time information and positional information as well as the identification information of the user S via the communication unit 16. The CPU 11 in the server computer 1 stores the transmitted information in the date-and-time storing file 155 as a history. FIG. 5 is an explanatory view illustrating a record layout of the date-and-time storing file 155. The date-and-time storing file 155 includes a transmission date-and-time field, a positional information field, a title field, a message field and the like.

In the date-and-time storing file 155, in addition to the title and message of the open information transmitted by the user, the information on the date and time when the open information is transmitted, and the positional information of the mobile phone 2 at the time of transmission of the open information are stored for each user as a history. In FIG. 5, the open information of the user S is indicated. In the transmission date-and-time field, the transmission date and time of the open information, more specifically, the date and time when the user operates the register button 44 through the input unit 23 of the mobile phone 2, is stored. Though the transmission date and time of the open information by the mobile phone 2 is used in the present Embodiment, the date and time when the CPU 11 in the server computer 1 receives the open information from the mobile phone 2 may also be employed.

Stored in the positional information field are the latitude and the longitude, i.e., the positional information, obtained at the time point where the mobile phone 2 transmits open information. The title of the transmitted open information is stored in the title field, whereas the message of the transmitted open information is stored in the message field. The message, which is a part of the open information, will be unspecified by a converting process, which will be described later. In the message field of the date-and-time storing file 155, however, both the message before the converting process and the message after the converting process are stored. The CPU 11 stores open information, transmission date and time, and positional information in the date-and-time storing file 155 every time these pieces of information are transmitted. For example, the fact that the title “event” and the message as illustrated in FIG. 4 are transmitted from the mobile phone of the user S from a position of the latitude x and the longitude y at 10 o'clock on May 25, 2007 is stored in the date-and-time storing file 155. Moreover, the fact that the open information with the title “music” is transmitted from a different location on 30th, which is five days later, is also stored. Note that image data is not illustrated in the example of FIG. 5. Since the data layout in each DB and file is merely an example, it is not limited thereto and may be designed as desired.

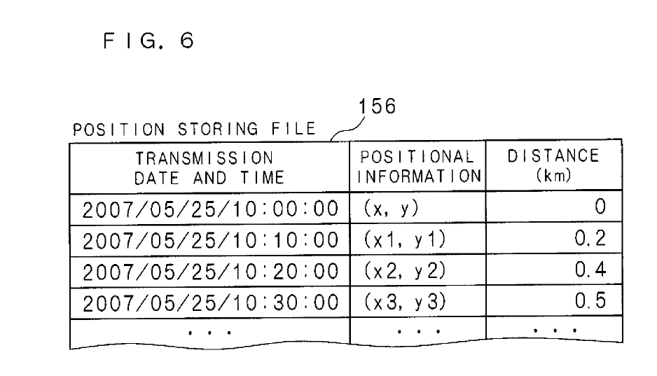

FIG. 6 is an explanatory view illustrating a record layout of the position storing file 156. The position storing file 156 includes a transmission date-and-time field, a positional information field and a distance field. After transmitting open information, the CPU 21 of the mobile phone 2 transmits positional information output from the GPS receiver 212 to the server computer 1 along with the date-and-time information at certain time intervals. The server computer 1 stores the transmitted positional information in the position storing file 156 together with the transmitted date-and-time information by associating them with the identification information of the user S.

The transmission date-and-time field stores therein the date and time at which the present positional information is transmitted by the mobile phone 2. In the present Embodiment, positional information is transmitted to the server computer 1 every 10 minutes. In the positional information field, positional information, i.e., the latitude and the longitude, transmitted from the mobile phone 2 is stored. Furthermore, stored in the distance filed is the distance between the position of the mobile phone 2 at the time point when the open information is first transmitted and the present position of the mobile phone 2 in units of kilometers. The CPU 11 calculates the distance using information regarding the latitude and longitude at the time point where the open information is first transmitted and regarding the latitude and longitude transmitted next, and stores the distance by associating it with the transmitted latitude and longitude.

For example, the open information of the title “event” is transmitted from a geographical point of the latitude x and the longitude y at 10 o'clock on May 25, 2007. Subsequently, at 10:10 on May 25, 2007, which is 10 minutes later, the positional information of the latitude x1 and the longitude y1 is transmitted from the mobile phone 2 to the server computer 1. Here, the distance is stored as 0.2 km. As such, the mobile phone 2 keeps transmitting the positional information at regular intervals to the server computer 1 until a given period of time (e.g., 3 days) elapses. In the present Embodiment, an example where the mobile phone 2 transmits positional information to the server computer 1 in push style. It is also possible for the server computer 1 to demand transmission of positional information from the mobile phone 2. The CPU 21 of the mobile phone 2 may transmit the positional information to the server computer 1 in response to the demand.

The threshold distance storing file 153 stores therein a threshold distance to be used as a standard. For the threshold distance, an operator may input an appropriate value from the input unit 13, or alternatively the user may input a value through the input unit 23 of the mobile phone 2 along with registration of the user's profile such as his/her gender, hobby and the like. In the latter case, the input threshold distance is transmitted to the server computer 1, and then the CPU 11 of the server computer 1 stores the transmitted threshold distance by associating it with the identification number of the user. The threshold distance corresponds to a numeric value used in comparison with a direct distance calculated based on the positional information obtained when open information is transmitted by the mobile phone 2 and the current positional information of the mobile phone 2. When the direct distance is equal to or longer than the threshold distance, the CPU 11 performs an unspecifying process on the open information and then transmits the unspecified open information to the personal computer 3. In the present Embodiment, the threshold distance of 10 km is employed for example.

In the threshold time storing file 154, threshold time to be used as a standard is stored. For the threshold time, an operator may input an appropriate value from the input unit 13, or alternatively the user may input a value through the input unit 23 of the mobile phone 2 along with registration of the user's profile. In the latter case, the input threshold time is transmitted to the server computer 1, and the CPU 11 of the server computer 1 stores the transmitted threshold time by associating it with an identification number of the user. The threshold time corresponds to a numeric value used in comparison with the difference between the date and time at which the mobile phone 2 transmitted the open information and the present date and time output by the clock unit 18. If the difference is equal to or more than the threshold time, the CPU 11 performs an unspecifying process on the open information and then transmits the unspecified open information to the personal computer 3. In the present Embodiment, the threshold time of 10 hours is employed for example. Though the present Embodiment describes an example where the unspecified information is transmitted when the direct distance is equal to or longer than the threshold distance and when the difference in date and time is equal to or more than the threshold time, it is not limited thereto. The unspecified open information may be transmitted, for example, when the direct distance is equal to or longer than the threshold distance, or when the difference in date and time is equal to or more than the threshold time.

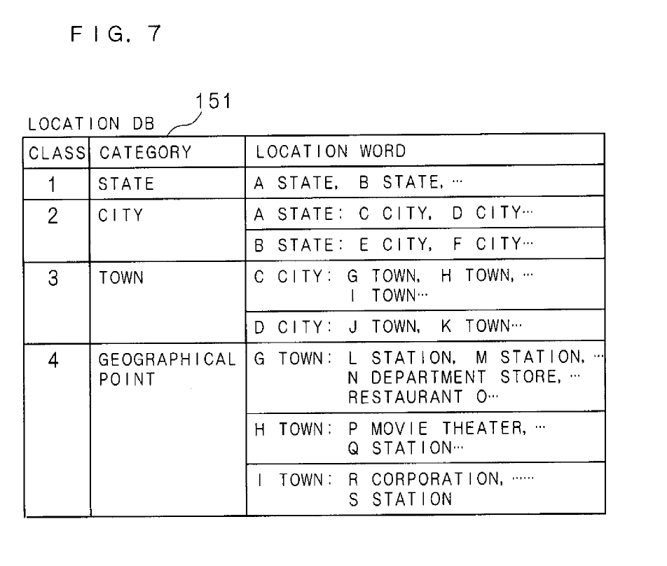

FIG. 7 is an explanatory view illustrating a record layout of the location DB 151. The location DB 151 is a database in which words indicating locations are sorted in accordance with a plurality of classes, including a class field, a category field and a location word field. In the class field, a class for sorting out the words indicating locations is stored. In the present Embodiment, four phases of classes are provided to facilitate explanation, wherein the class with the smallest value of 1 belongs to the highest class. In the category field, a category for sorting out the words indicating locations is stored in association with each class.

In the present Embodiment, a category “state” is stored in the category 1, the highest category. In the location word field, a word belonging to the category is stored in association with the class and the category. For example, in class 1, A state, B state or the like are stored as a state. In the class 2 which is the next highest class, a category “city” is stored, while a word indicating a location corresponding to the category is stored in association with the word indicating a location belonging to a higher class. For example, in the category “city” of class 2, C city, D city and the like which belong to A state of class 1 are stored. Likewise, E city, F city and the like are stored which belong to B state of class 1.

In the next highest class 3, a category “town” is stored, while a word indicating a location corresponding to this category is stored in association with the word indicating a location belonging to a higher class. For example, in the category “town” of class 3, G town, H town and the like which belong to C city of class 2 are stored. Finally, in the lowest class of class 4, a category “geographical point” is stored, while a word indicating a location corresponding to this category is stored in association with the word indicating a location belonging to a higher class.

For example, in the category “geographical point” of class 4, L station, M station, N department store and the like which belong to G town of class 3 are stored. For such a database, map data and the like used in a car navigation system or the like may be utilized. The CPU 11 refers to the location DB 151 to extract a word indicating a location in open information. When the word indicating a location is extracted, the CPU 11 converts the extracted word into a word indicating a location of a higher class to which the extracted word belongs. For example, when L station of class 4 is extracted, the CPU 11 performs a process of converting L station into G town of class 3, which is a higher class to which L station belongs. Moreover, when E city of class 2 is extracted, for example, it is converted into B state of the category 1 to which E city belongs. Hence, information indicating a position entered by the user is unspecified while maintaining accuracy to some extent. Though the present Embodiment described an example where a word is converted into a word of a one-phase higher class, it is not limited thereto. A word may also be converted into a word belonging to a class two phases higher.

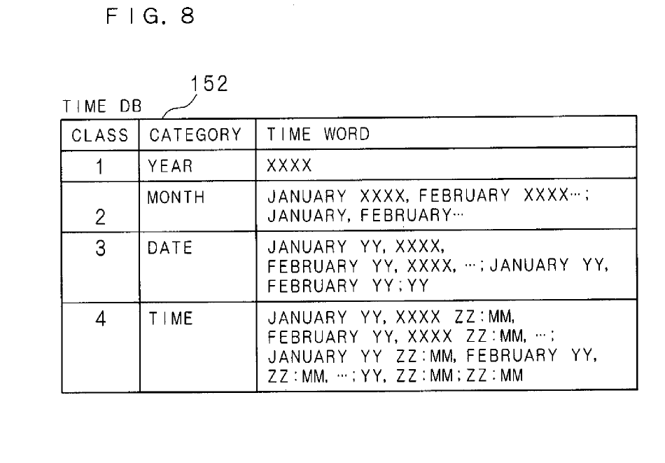

FIG. 8 is an explanatory view illustrating a record layout of the time DB 152. The time DB 152 is a database in which words indicating time are sorted out in accordance with a plurality of classes, including a class field, a category field and a time word field. In the class field, a class for sorting out words indicating time is stored. In the present Embodiment, four phases of classes are provided to facilitate explanation, wherein the class with a smallest numeric value of 1 corresponds to the highest class. In the category field, an attribute for sorting out the words indicating time is stored in association with each class. For example, in association with the class 1 of the highest class, a category “year” which is an attitude of a word indicating the corresponding time is stored.

In the time word field, a word indicating time in association with a class and a category is stored. For the category “year” of class 1, “XXXX” is stored. It is noted that the letter X is a wild card, meaning that any arbitrary integer may be employed. A category “month” is stored in association with the next highest class of class 2. In the time word field, “a combination of month and year” and “month,” which belong to a class lower than “year” of a higher class of class 1. For example, the combination of month and year may be January XXXX. As for “month,” the twelve months from January to December are stored. In association with class 3 which is the third highest class, a category “date” is stored. In the time word field, “a combination of month, date and year,” “a combination of month and date” and “date,” which belong to a class lower than the higher class 2 are stored. For example, as a combination of month, date and year, “January YY, XXXX” is stored. Note that Y is also a wild card, meaning that it may be any arbitrary integer. As a combination of month and date, “January YY” is stored. As a date, “YY” is stored. In place of “date,” “day of the week” may also be stored.

Likewise, a category “time” is stored in association with class 4 of the fourth highest class. In the time word field, “a combination of month, date, year and time,” “a combination of month, date and time,” “a combination of date and time” and “time” is stored. For example, as a combination of month, date, year and time, January YY, XXXX ZZ:MM may be stored. Note that Z and M are also integer wild cards. As a combination of month, date and time, January YY, ZZ:MM is stored. An example of a combination of date and time may be YY ZZ:MM. Such information may be input by an operator through the input unit 13.

The CPU 11 refers to the time DB 152 to extract a word indicating time included in open information. When the word indicating time is extracted, the CPU 11 converts the extracted word into a word indicating time of a class higher than the class to which the extracted word belongs in order to unspecify the extracted word. For example, when “January 26, 2007” of class 3 is extracted, the CPU 11 performs a process of converting it into “January 2007” of class 2 which is a higher class. Moreover, when the extracted word is “January 26, 11:00” of class 4, the CPU 11 refers to “January 26” of a higher class of class 3 and the present year, to convert it into “January 26, 2007” or simply “26.” Accordingly, the information indicating time entered by the user is unspecified while maintaining accuracy to some extent. Though a word indicating a location or time included in a message is converted in the present Embodiment, it is understood that a word indicating a location or time included in a title may also be converted. The present Embodiment illustrated an example where the converting process is executed by the server computer 1. It may, however, also be possible that the location DB 151 and the time DB 152 are stored in the mobile phone 2, and the CPU 21 of the mobile phone 2 may execute the converting process. In such a case, messages before and after conversion are transmitted to the server computer 1 based on the instructions of the CPU21 of the mobile phone 2.

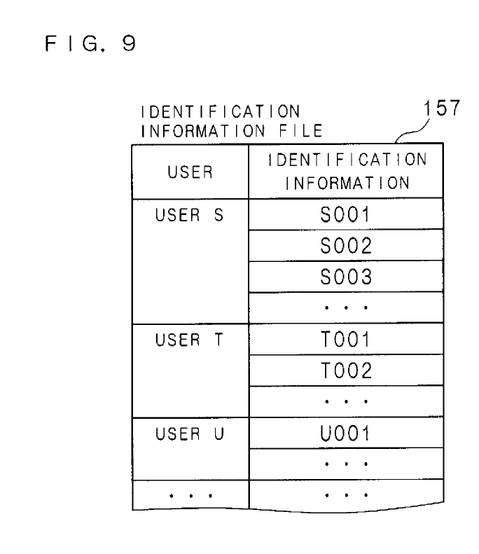

FIG. 9 is an explanatory view illustrating a record layout of the identification information file 157. The identification information file 157 includes a user field and an identification information field. In the identification information file 157, identification information regarding other users, for which the user S who transmits open information allows viewing thereof in real time before unspecifying, is stored for each user. In the description below, a user who is stored in the identification information file 157 and is able to view open information in real time before unspecifying is referred to as a limited user, while the other users are referred to as general users.

The identification information is, for example, an e-mail address or an ID used to login SNS. The user S inputs, through the input unit 23 of the mobile phone 2, identification information of another user who is allowed to be registered as a limited user. The input identification information is transmitted to the server computer 1 along with the identification information of the user S. The CPU 11 of the server computer 1 stores the identification information of the limited user in association with the transmitted identification information of the user S in the identification information field. Though the present Embodiment described an example where a general user is distinguished from a limited user, it is also possible to uniformly process all users as general users without a limited user employed.

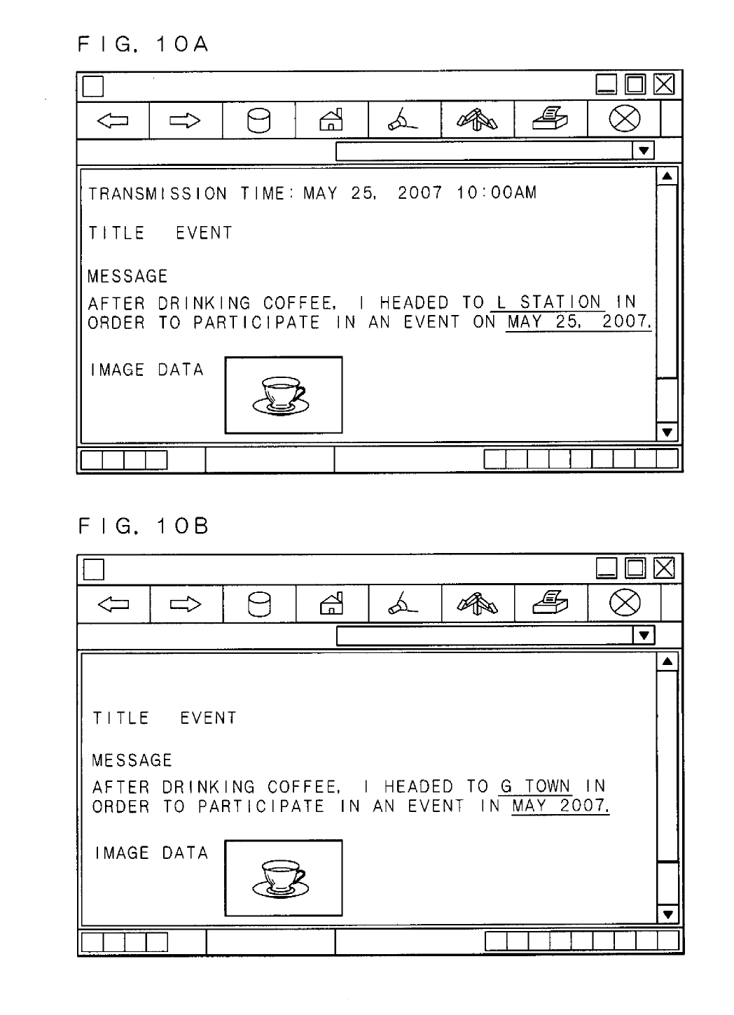

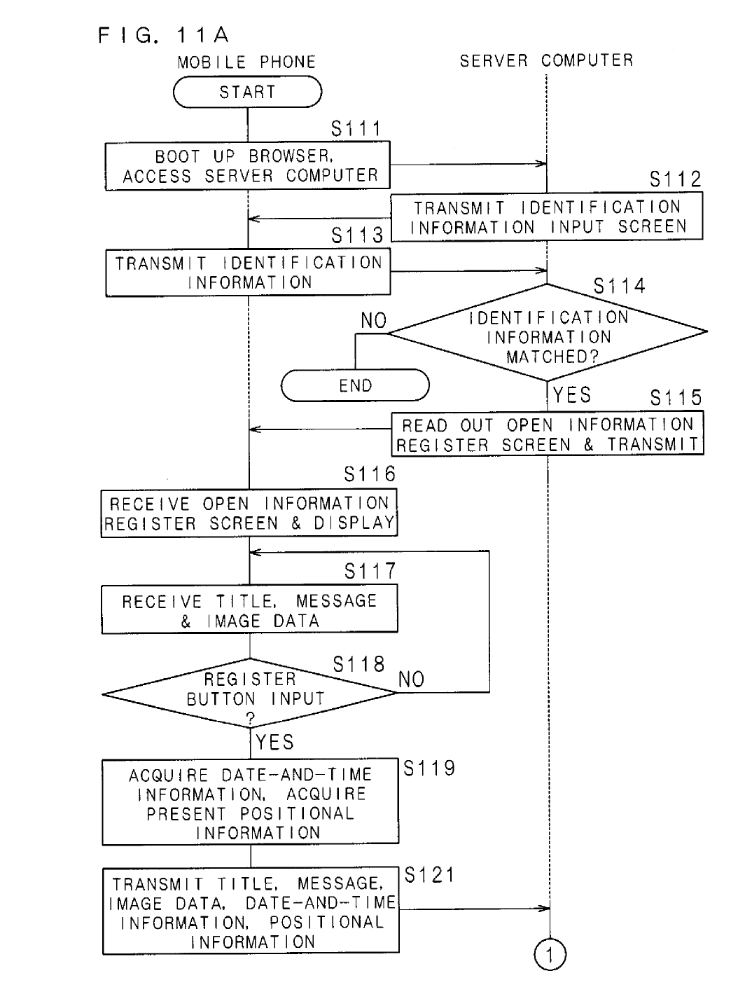

FIGS. 10A and 10B are explanatory views illustrating display images of open information. FIG. 10A is an explanatory view illustrating a display image viewable by a limited user, whereas FIG. 10B is an explanatory view illustrating a display image viewable by a general user. FIG. 10 illustrates an example based on the example in FIG. 4. When the open information for the user S stored in the date-and-time storing file 155 is displayed, the CPU 11 judges whether or not the identification number transmitted from the personal computer 3 matches with the identification information stored in the identification information file 157. If it is judged that they match with each other, the CPU 11 reads out a transmission date and time, a title, a message and a thumbnail of image data that are stored in the date-and-time storing file 155 and creates an HTML document.

The CPU 11 transmits the created document to the personal computer 3. As illustrated in FIG. 10A, the browser of the personal computer 3 displays the date and time when the user transmitted open information, the title, the message and the thumbnail of image data without changing or unspecifying them. If it is judged that the identification number transmitted from the personal computer 3 does not match with the identification information stored in the identification information file 157, the CPU 11 determines that the present user is a general user. The CPU 11 then calculates a difference (elapsed time) based on the date and time output by the clock unit 18 and the transmission date and time stored in the date-and-time storing file 155.

The CPU 11 reads out threshold time from the threshold time storing file 154, to judge whether or not the calculated difference is equal to or more than the threshold time and the distance stored in the position storing file 156 is equal to or longer than the threshold distance stored in the threshold distance storing file 153. If it is judged as equal to or more than the threshold time and equal to or longer than the threshold distance, the CPU 11 transmits the open information on which an unspecifying process has been performed using the location DB 151 and the time DB 152. If it is judged as less than the threshold time or shorter than the threshold distance, the CPU 11 halts transmission of open information to the personal computer 3 and instead transmits a screen including a text stored in the storage unit 15, indicating that the information has not been released. In FIG. 10B, an example is illustrated where L station is converted into G town which belongs to a higher class, while May 25, 2007 is converted into May 2007. As such, time lag due to the distance and time as well as unspecifying of the information to be released allow further enhancement in security, making it possible to appropriately protect the user's privacy.

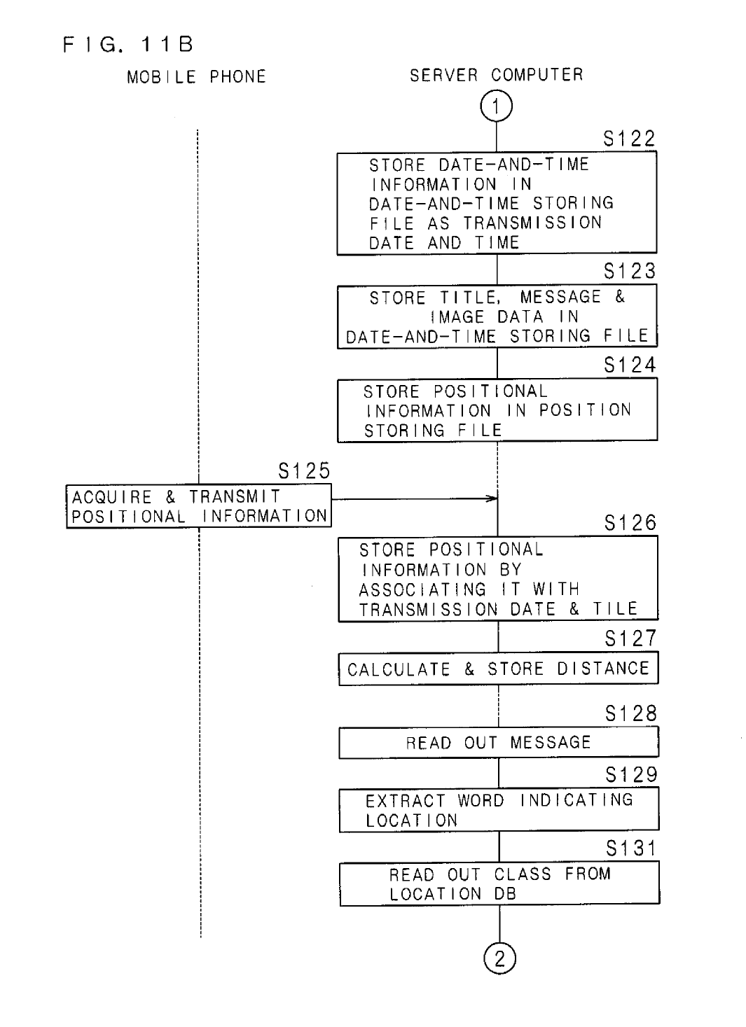

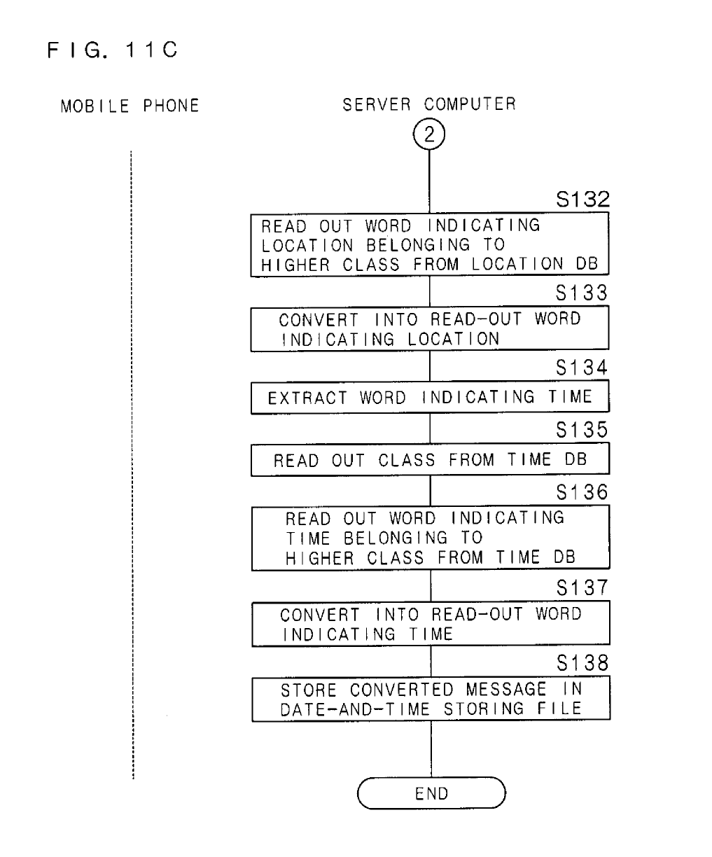

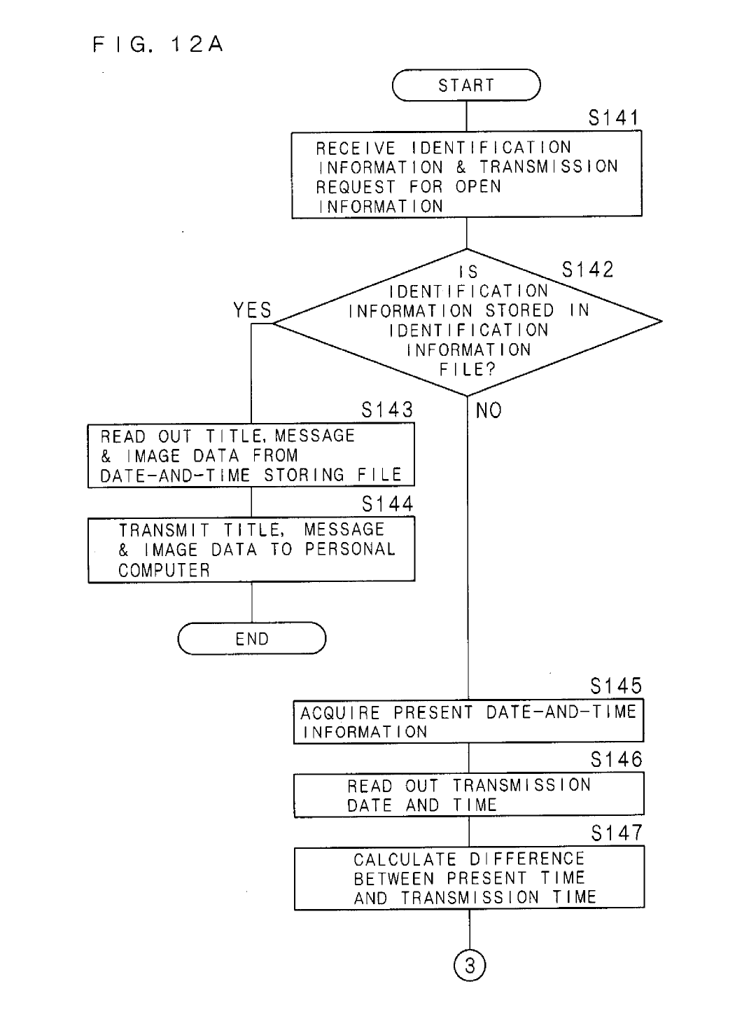

The procedure of each software processing performed in the hardware devices described above will be described using a flowchart. FIGS. 11A to 11C depict a flowchart illustrating the procedure of the process of registering and converting open information. The user operates the input unit 23 of the mobile phone 2 to input URL of the server computer 1 managing SNS. In response to the input of URL from the input unit 23, the CPU 21 boots up the browser 251 and accesses the server computer 1 (step S111). The CPU 11 of the server computer 1 reads out from the storage unit 15 an identification information input screen for logging in SNS, and transmits the screen to the mobile phone 2 via the communication unit 16 (step S112).

The CPU 21 of the mobile phone 2 receives the identification information input screen transmitted via the communication unit 26. The CPU 21 displays the received identification information input screen on the browser 251, and receives input of the identification information from the input unit 23. The CPU 21 transmits the received identification information to the server computer 1 (step S113). The CPU 11 of the server computer 1 receives the transmitted identification information and judges whether or not the received identification information matches with the identification information pre-stored in the storage unit 15 (step S114). If it is judged that there is no matching (NO at the step S114), the CPU 11 determines that the access is unauthorized and terminates the processing. If, on the other hand, it is judged that they match with each other (YES at the step S114), the CPU 11 reads out the open information registering screen described with reference to FIG. 4, to transmit it to the mobile phone 2 (step S115).

The CPU 21 of the mobile phone 2 receives the open information registering screen and displays it on the browser 251 (display unit 24) (step S116). The user inputs a title and a message through the input unit 23, and also selects from the storing unit 25 arbitrary image data among the image data shot by the camera 29. The CPU 21 receives the input title, the message, and the selected image data (step S117). The CPU 21 judges whether or not the register button 44 is input from the input unit 23 (step S118). If it is judged that the register button 44 is not input (NO at the step S118), the CPU 21 moves to the step S117 and repeats the processing described above. If, on the other hand, it is judged that the register button 44 is input (YES at the step S118), the CPU 21 acquires date-and-time information with reference to the date-and-time information output by the clock unit 28, and also acquires the present positional information from the GPS receiver 212 (step S119).

The CPU 21 transmits the received title, message and image data as well as the acquired date-and-time information and the positional information to the server computer 1 (step S121). The CPU11 of the server computer 1 stores the date-and-time information transmitted at the step S121 in the date-and-time storing file 155 as the transmission date and time, as illustrated in FIG. 5 (step S122). The CPU 11 stores the transmitted title, message and image data in the date-and-time storing file 155 by associating them with the stored transmission date and time (step S123). The CPU 11 stores the positional information including the latitude and longitude by associating it with the transmission date and time transmitted at the step S121, as illustrated in FIG. 6 (step S124).

The user who carries the mobile phone 2 either moves by walking, a car, a train or the like, or stays in place. The CPU 21 of the mobile phone 2 acquires the present positional information from the GPS receiver 212 on a regular basis with reference to the date-and-time information output by the clock unit 28, and transmits the acquired positional information to the server computer 1 (step S125). The CPU 11 of the server computer 1 receives the positional information every time it is transmitted from the mobile phone 2, and sequentially stores the transmission date and time obtained by referring to the date-and-time information output by the clock unit 18 together with the transmitted positional information as a history regarding movement of the mobile phone 2 (step S126).

The CPU 11 calculates a distance based on the positional information stored at the step S124 and the positional information received at the step S126, and stores the calculated distance in the position storing file 156 by associating it with the positional information stored at the step S126 (step S127). Note that the processes from the step S125 to the step S127 are repeatedly executed until a given time period (e.g. 24 hours) stored in the storage unit 15 has elapsed.

The CPU 11 reads out the message stored in the date-and-time storing file 155 (step S128). The CPU 11 performs morphological analysis on the message and divides it into a plurality of words. From the words included in the message, the CPU 11 extracts a word indicating a location with reference to the location DB 151 (step S129). The CPU 11 reads out a class corresponding to the extracted word indicating a location with reference to the location DB 151 (step S131). The CPU 11 then reads out a word indicating a location belonging to a class one phase higher than the read out class, with reference to the location DB 151 (step S132). Finally, the CPU 11 converts the word indicating a location read out at the step S129 into a word indicating a location of a higher concept read out at the step S132 (step S133).

Likewise, for the words included in the message, the CPU 11 extracts a word indicating time with reference to the time DB 152 (step S134). The CPU 11 reads out a class corresponding to the extracted word indicating time with reference to the time DB 152 (step S135). The CPU then reads out a word indicating time which belongs to a class one phase higher than the read-out class, with reference to the time DB 152 (step S136). Finally, the word indicating time read out at the step S134 is converted into a word of a higher concept indicating time which has been read out at the step S136 (step S137). The CPU 11 stores the message obtained after conversion at the steps S133 and S137 in the date-and-time storing file 155 by associating it with the message before conversion (step S138). This allows both the message after conversion which is unspecified for a general user and the not-unspecified original message for a limited user to be stored in the date-and-time storing file 155.

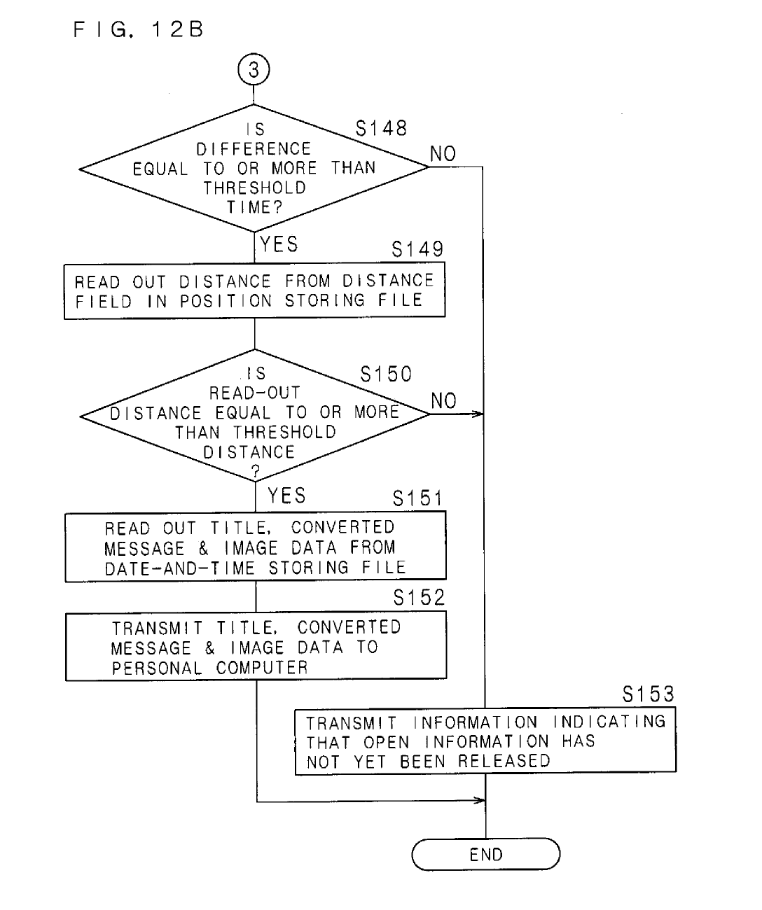

FIGS. 12A and 12B depict a flowchart illustrating the procedure used when open information is transmitted. A general user or a limited user who wishes to view the open information transmitted by the user S boots up the browser of the personal computer 3 to access the server computer 1. The CPU 11 of the server computer 1 transmits a screen for logging in SNS. A general or limited user inputs an identification number to login. The CPU 11 of the server computer 1 receives the identification information and a transmission request for the open information, which are transmitted from the personal computer 3 (step S141).

The CPU 11 performs a process described below in transmitting the user S's open information stored at the step S138 to a general or limited user. The CPU 11 judges whether or not the transmitted identification information concerning a user to which the open information is released is stored in the identification information file 157 (step S142). The CPU 11 refers to the identification information file 157 to judge whether or not the transmitted identification information is stored as the identification information concerning the user to which the open information is released. For example, when the open information of the user S is transmitted, the CPU 11 judges whether or not the transmitted identification number is “S001,” “S002,” “S003” or the like.

If it is judged that the transmitted identification information is stored in the identification information file 157 as the identification information concerning the user to which the open information is released, the CPU 11 determines that the user of the personal computer 3 is a limited user, and reads out the title, message and image data from the date-and-time storing file 155 (step S143). The CPU 11 then converts the title, message and image data into an HTML document to transmit it to the personal computer 3 of the limited user (step S144), and terminates the process. Note that no unspecifying process is performed on the message read out and transmitted at the steps S143 and S144.

If, on the other hand, it is judged that the transmitted identification information is not stored in the identification information file 157 as the identification information concerning the user to which the open information is released (NO at the step S142), the CPU 11 determines that the user of the personal computer 3 is a general user, and acquires information on the present date and time with reference to the output by the clock unit 18 (step S145). The CPU 11 reads out the transmission date and time stored in the date-and-time storing file 155 (step S146). The CPU 11 calculates the difference between the present date and time information acquired at the step S145 and the transmission date and time read out at the step S146 (step S147).

The CPU 11 judges whether or not the calculated difference is equal to or more than the threshold time stored in the threshold time storing file 154 (step S148). If it is judged that the difference is equal to or more than the threshold time (YES at the step S148), the CPU 11 reads out the distance from the distance field in the position storing file 156 (step S149). Note that the distance read out from the distance field may be either a distance with the latest transmission date and time or a maximum distance in the distance field. In the present embodiment, the distance corresponding to the latest transmission date and time indicating the present position of the mobile phone 2 is read out.

The CPU 11 judges whether or not the read-out distance is equal to or more than the threshold distance stored in the threshold distant storing file 153 (step S150). If it is judged that the read-out distance is equal to or more than the threshold distance (YES at the step S150), the CPU 11 reads out the title, the unspecified message after conversion and the image data from the date-and-time storing file 155 (step S151). The CPU 11 then converts the title, converted message and image data into an HTML document to transmit it to the personal computer 3 of a general user (step S152). If it is judged that the difference is less than the threshold time at the step S148 (NO at the step S148) and that the distance is less than the threshold distance at the step S150 (NO at the step S150), the CPU 11 transmits information indicating that the open information has not yet been released in order to protect the privacy (step S153). For example, a message such as “please wait for a moment” stored in the storage unit 15 may be read out and transmitted to the personal computer of a general user.

### Embodiment 2

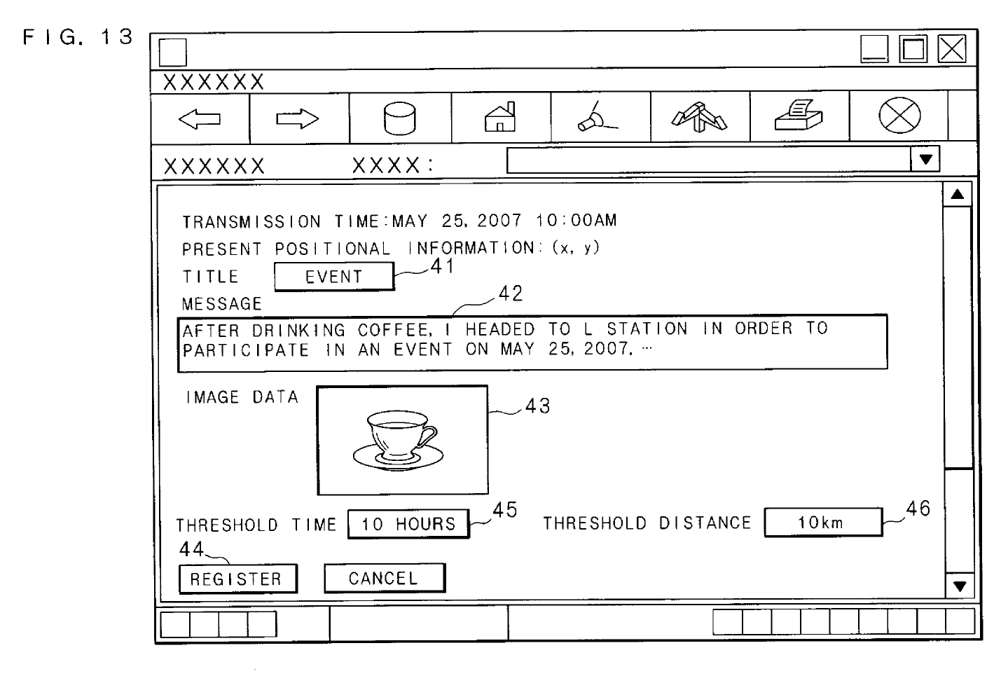

Embodiment 2 relates to an example where the threshold distance and threshold time are increased in accordance with words included in open information. FIG. 13 is an explanatory view illustrating an image obtained when open information is registered according to Embodiment 2. In addition to Embodiment 1, a threshold time input box 45 and a threshold distance input box 46 are newly provided. The open information registering screen is stored in the storage unit 15 of the server computer 1, which is read out in response to a request when the user is registering open information and transmitted to the mobile phone 2. The CPU 21 of the mobile phone 2 displays the open information registering screen illustrated in FIG. 13 on the browser 251. The user inputs desired threshold time through the threshold time input box 45 and a desired threshold distance through the threshold distance input box 46.

In the example of FIG. 13, the threshold time is input as 10 hours, while the threshold distance is input as 10 km. The CPU 11 receives the input threshold time and threshold distance together with the title, image data and message, and transmits the input threshold time, threshold distance, title, image data and message to the server computer 1 when the register button 44 is pressed, which is regarded as a trigger. In the present Embodiment, the threshold time and distance to be based on are increased depending on the existence of a word indicating location and a word indicating time included in a message, and further increased in accordance with the releasing status indicating whether or not another message is released to general users.

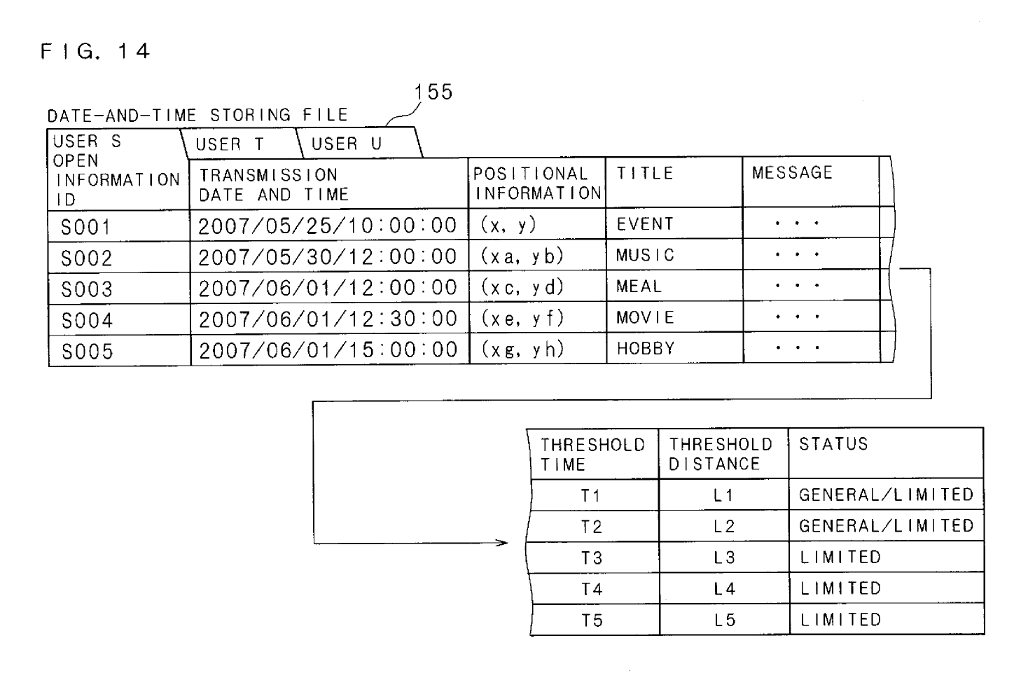

FIG. 14 is an explanatory view illustrating a record layout of a date-and-time storing file 155 according to Embodiment 2. In addition to Embodiment 1, the date-and-time storing file 155 includes an open information ID field, a threshold time field, a threshold distance field and a status field. The date-and-time storing file 155 stores therein open information transmitted from the mobile phone 2 of each user as a history, and also stores threshold time and threshold distance calculated by a process described later based on the transmitted threshold time and threshold distance. In the open information ID field, a unique open information ID for identifying transmitted open information is stored. For example, the open information ID for the open information transmitted at 10 o'clock on May 25, 2007 is S001. Every time when open information is newly transmitted, a new open information ID is assigned and stored. For example, the open information ID for the open information transmitted at 15 o'clock on June 1, 2007 is S005. Since the transmission date-and-time field, positional information field, title field and message field are as described in Embodiment 1, description thereof will not be repeated here. Though no image data is illustrated in FIG. 14, it is stored in association with open information ID.

In the threshold time field, the threshold time determined by a process described later is stored based on the instructions by the CPU 11. Note that the threshold time is stored in the threshold time storing file 154 in association with the user's identification information and the open information ID. Likewise, in the threshold distance field, the threshold distance determined by a process described later is stored based on the instructions by the CPU 11. The threshold distance is stored in the threshold distance storing file 153 in association with the user's identification information and the open information ID.

In the status field, a releasing status of open information is stored. As described in Embodiment 1, when the difference between the time when open information is transmitted and the present time is equal to or more than the threshold time and the distance obtained based on the positional information of the mobile phone 2 at the time point where open information is transmitted and the present positional information of the mobile phone 2 is equal to or longer than the threshold distance, the open information is released to a limited user, while converted open information is released to a general user. Hereinafter, the case where a limited user may view open information before conversion while a general user may view the converted open information will be referred to as a general/limited status. The other cases, i.e., when the difference in time is less than the threshold time or the difference in distance is less than the threshold distance, open information may only be viewable by a limited user. This will be referred to as a limited status.

If the CPU 11 judges that the difference between the present time and the transmission time is equal to or more than the threshold time stored in the threshold time field, and that the newest distance stored in the position storing file 156 is equal to or longer than the threshold distance, it is determined as the general/limited status. The CPU 11 stores such information in the status field. In other cases, the CPU 11 determines that the present status is the limited status and stores the information in the status field. In the present Embodiment, the open information with the open information IDs of S001 and S002 are in the general/limited status, whereas the open information with the open information IDs of S003 to S005 are in the limited status.

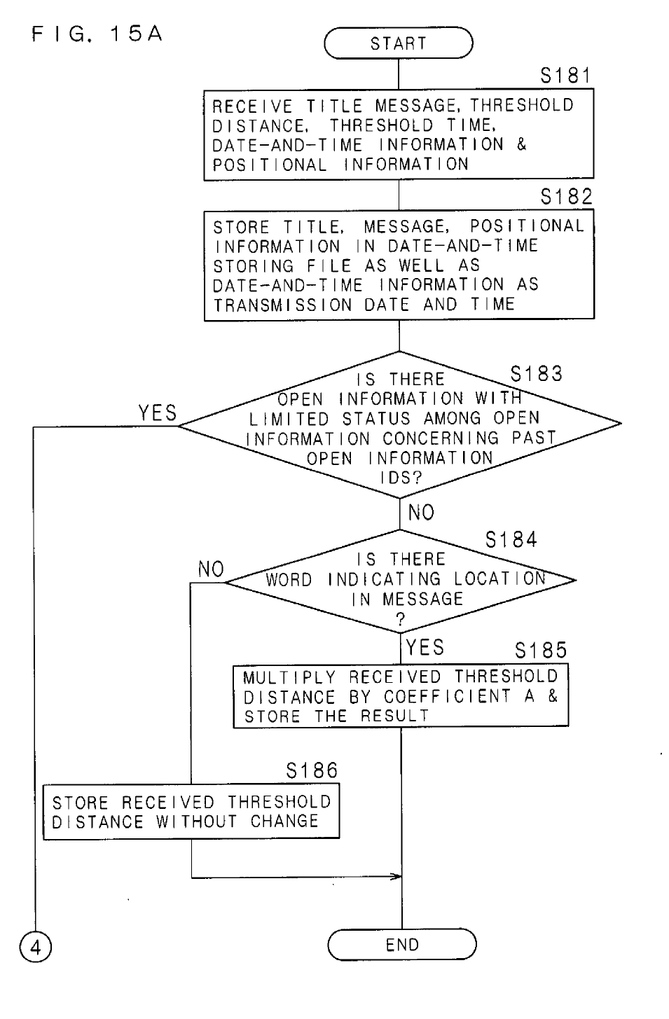

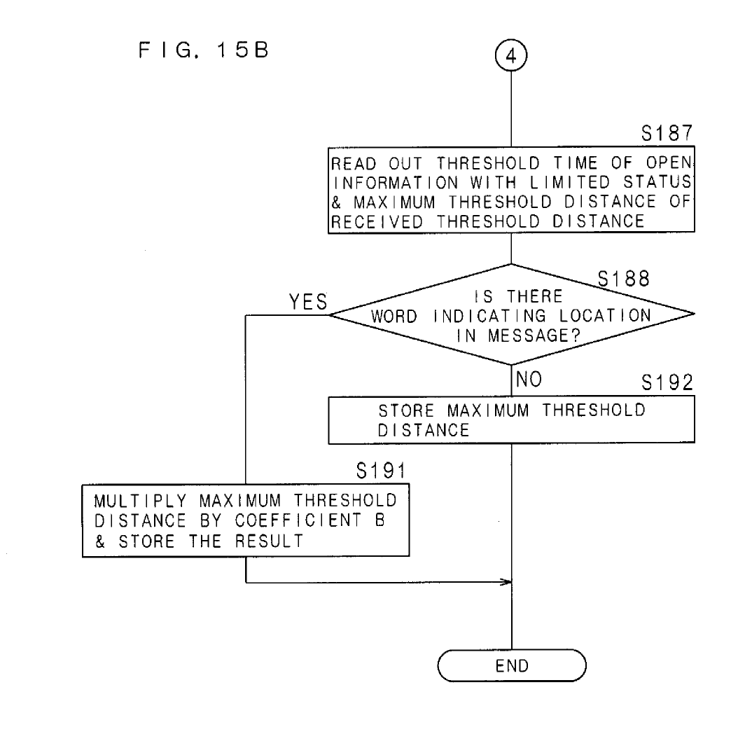

Next, the procedure of a process of determining the threshold time and threshold distance will be described using a flowchart, with reference to specific examples of FIG. 14. FIGS. 15A and 15B depict a flowchart illustrating the processing procedure used when the threshold distance is determined. The CPU 11 of the server computer 1 receives the title, message, threshold distance, threshold time, date-and-time information, positional information and the like transmitted from the mobile phone 2 (step S181). The CPU 11 stores the received title, message and positional information in the date-and-time storing file 155, and also stores the received date-and-time information in the date-and-time storing file 155 as a transmission date and time (step S182). The processing performed at the steps S181 and S182 is as described in Embodiment 1.

The CPU 11 then judges whether or not there is open information with the limited status in the open information concerning past open information IDs in the date-and-time storing file 155 (step S183). More specifically, the CPU 11 refers to the status field for the past open information other than the open information for which the threshold distance is determined by present registration, to extract the open information with the limited status stored. In the example of FIG. 14, the past open information with IDs S003 and S004 which have been stored before the open information ID to be registered this time are in the limited status. When the past open information is still in the limited status, meaning that the user intensively resisters open information, a risk of position and time being identified is raised. To avoid the risk, the process of increasing the threshold distance to be more than that input by the user is performed as will be described below.

If it is judged that there is no open information with limited status in the open information concerning the past open information IDs in the date-and-time storing file 155 (NO at the step S183), the CPU 11 judges whether or not there is a word indicating a location in a message with reference to the location DB 151 (step S184). If it is judged that there is a word indicating a location in the message (YES at the step S184), the CPU 11 multiplies the threshold distance received at the step S181 by a coefficient A stored in the storage unit 15, and stores the obtained threshold distance in the threshold distance field in the date-and-time storing file 155 and in the threshold distance storing file 153, by associating it with the open information ID (step S185). The coefficient A is, for example, a value larger than 1. It is set as 1.2 in the present Embodiment. For the open information ID S005, a threshold distance L5 multiplied by the coefficient of 1.2 is stored as illustrated in FIG. 14.

If, on the other hand, it is judged that there is no word indicating a location in the message (NO at the step S184), the threshold distance received at the step S181 is stored as it is in the threshold distance field in the date-and-time storing file 155 and in the threshold distance storing file 153, by associating it with the open information ID (step S186). When there is no language indicating a location, a risk of a location being identified decreases. Thus, the received threshold distance is utilized without a change.

If it is judged that there is open information with the limited status in the open information concerning the past open information IDs in the date-and-time storing file 155 at the step S183 (YES at the step S183), the CPU 11 reads out the maximum threshold distance among the threshold distance for the open information with the limited status and the threshold distance received at the step S181 (step S187). In the example of FIG. 14, the threshold distance in the limited status is L3 and L4, while the received threshold distance is 10 km. Among L3, L4 and 10 km, the maximum distance is selected in consideration of the relationship with the other open information and an extra distance.

The CPU 11 judges whether or not there is a word indicating a location in the message (step S188). If it is judged that there is a word indicating a location in the message (YES at the step S188), the CPU 11 multiplies the maximum threshold distance read out at the step S187 by a coefficient B stored in the storage unit 15, and stores the obtained threshold distance in the threshold distance field in the date-and-time storing file 155 and in the threshold distance storing file 153, by associating it with the open information ID (step S191). For the coefficient B, a value equal to or larger than the coefficient A is set. In the present Embodiment, a value of 1.5 is stored as the coefficient B. Though a coefficient is multiplied for increasing a distance in the present Embodiment to facilitate explanation, it is understood that a coefficient may also be added. For example, when the threshold distance is in kilometer units, 5 km may be added. When it is in meter units, 500 m may also be added.

If the CPU 11 judges that there is no word indicating a location in the message (NO at the step S188), the CPU 11 stores the maximum threshold distance read out at the step S187 in the threshold distance field of the date-and-time storing file 155 and in the threshold distance storing file 153, by associating it with the open information ID (step S192). This allows an optimal threshold distance to be set in accordance with the releasing condition of the past open information which has already been registered and with the existence of a word indicating a location included in a message.

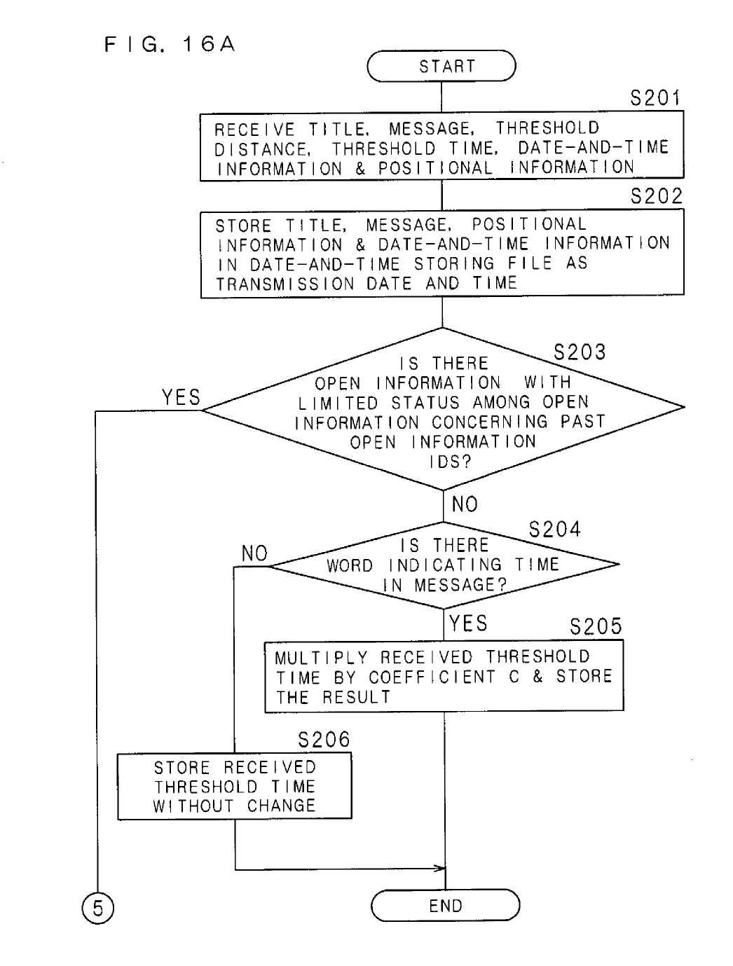

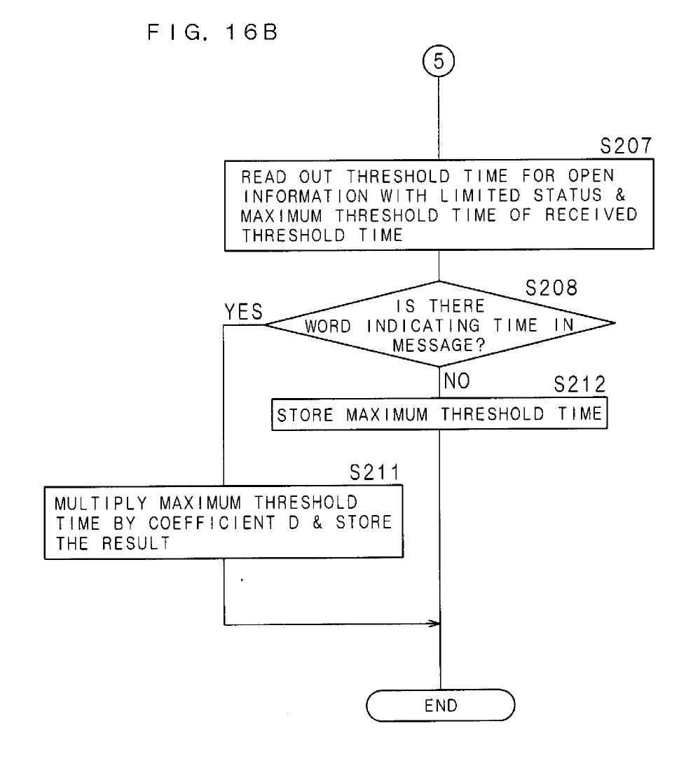

Likewise, as for the threshold time, optimal threshold time is determined by the processing described below. FIGS. 16A and 16B depict a flowchart illustrating the processing procedure used when the threshold time is determined. The CPU 11 of the server computer 1 receives the title, message, threshold distance, threshold time, date-and-time information, positional information and the like transmitted from the mobile phone 2 (step S201). The CPU 11 stores the received title, message and positional information in the date-and-time storing file 155, and also stores the received date-and-time information in the date-and-time storing file 155 as transmission date and time (step S202).

Next, the CPU 11 judges whether or not there is open information with the limited status among the open information concerning the past open information IDs in the date-and-time storing file 155 (step S203). More specifically, the CPU 11 refers to the status field of the past open information other than the open information for which the threshold time is determined by the present registration, to extract open information with the limited status stored. When the past open information is still in the limited status, meaning that the user is intensively registering open information, a risk of the position and time being identified is raised. To avoid the risk, the process of increasing the threshold time to be more than the threshold time input by the user is performed as will be described below.

If the CPU 11 judges that there is no open information with the limited status in the open information concerning the past open information IDs in the date-and-time storing file 155 (No at the step S203), it judges whether or not there is a word indicating time in the message with reference to the time DB 152 (step S204). If it is judged that there is a word indicating time in the message (YES at the step S204), the CPU 11 multiplies the threshold time received at the step S201 by a coefficient C stored in the storage unit 15, and stores the obtained threshold time in the threshold time field of the date-and-time storing file 155 and in the threshold time storing file 154, by associating it with the open information ID (step S205). The coefficient C is, for example, a value larger than 1. A value of 1.2 is employed in the present Embodiment. For the open information ID S005, threshold time T5 obtained by multiplying the received threshold by the coefficient of 1.2 is stored as illustrated in FIG. 14.

If, on the other hand, it is judged that there is no word indicating time in the message (NO at the step S204), the CPU 11 stores the threshold time received at the step S201 as it is in the threshold time field of the date-and-time storing file 155 and in the threshold time storing file 154, by associating it with the open information ID (step S206). When there is no language indicating time, meaning that the risk of time being identified decreases, the received threshold time is utilized without a change.

If the CPU 11 judges that there is open information with the limited status among the open information concerning the past open information IDs in the date-and-time storing file 155 at the step S203 (YES at the step S203), it reads out the maximum threshold time among the threshold time for the open information with the limited status and the threshold time received at the step S201 (step S207). In the example of FIG. 14, the threshold time in the limited status includes T3 and T4, while the received threshold time is 10 hours. The maximum threshold time is selected from T3, T4 and 10 hours in consideration of the relationship with the other open information and extra time.

The CPU 11 judges whether or not there is a word indicating time in the message (step S208). If it is judged that there is a word indicating time in the message (YES at the step S208), the CPU 11 multiplies the maximum threshold time read out at the step S207 by a coefficient D stored in the storage unit 15, and stores the threshold time obtained by the multiplication in the threshold time field of the date-and-time storing file 155 and in the threshold time storing file 154, by associating it with the open information ID (step S211). For the coefficient D, a value equal to or larger than the coefficient C is set. In the present Embodiment, a value of 1.5 is stored as the coefficient D. Though a coefficient is multiplied in the present Embodiment in order to increase the threshold time to facilitate explanation, it is understood that the coefficient may also be used for addition. For example, when the threshold time is in the unit of hours, three hours may be added. Also, when the threshold time is in the unit of days, two days may be added.

If the CPU 11 judges that there is no word indicating time in the message (NO at the step S208), it stores the maximum threshold time read out at the step S207 in the threshold time field of the date-and-time storing file 155 and in the threshold time storing file 154, by associating it with the open information ID (step S212). Thus, the optimal threshold time is set in accordance with the releasing status of the past open information which has already been registered and the existence of a word indicating time included in the message.

Embodiment 2 is as described above while the other parts are similar to those in Embodiment 1. Thus, the corresponding parts are denoted by the same reference number as those in Embodiment 1 and description thereof will not be repeated.

### Embodiment 3

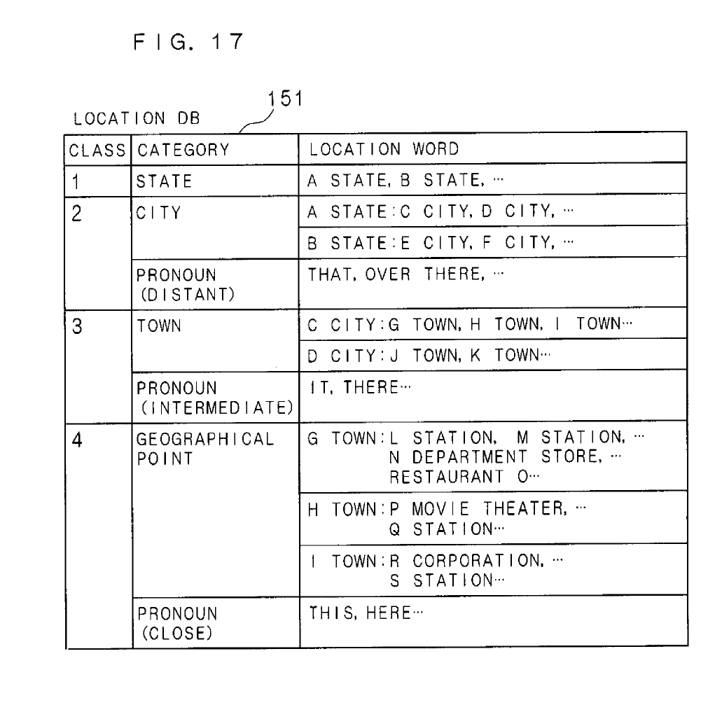

Embodiment 3 relates to an example where a demonstrative pronoun is included as a word indicating a location, while a word indicating past, present or future is included as a word indicating time. FIG. 17 is an explanatory view illustrating a record layout of the location DB 151. The word indicating a location includes a demonstrative pronoun. The demonstrative pronoun is a pronoun used for indicating a location or the like. A pronoun indicating a distant object includes “that,” “over there” and the like, a pronoun indicating an intermediate object includes “it,” “there” and the like, and a pronoun indicating a close object includes “this,” “here” and the like.

The pronoun indicating a close object belongs to the class 4, which is the same as “geographical point” as illustrated in FIG. 17, including “this,” “here” and the like stored in the location word field. The pronoun indicating an intermediate object belongs to the class 3, which is the same as “town” and is a class higher than that indicating a close object, including “it,” “there” and the like. Furthermore, the pronoun indicating a distant object belongs to the class 2, which is the same as “city” and is a class higher than the pronoun indicating an intermediate object, including “that,” “over there” and the like. Looking at the group of words, “this” is in a lower class than “it,” and “it” is in a lower class than “that,” while “this,” “it” and “that” belong to the same group. Moreover, “here” is in a lower class than “there,” and “there” is in a lower class than “over there,” while “here,” “there” and “over there” belong to the same group. When executing the unspecifying process on a demonstrative pronoun, the CPU 11 converts it into a demonstrative pronoun of a higher class.

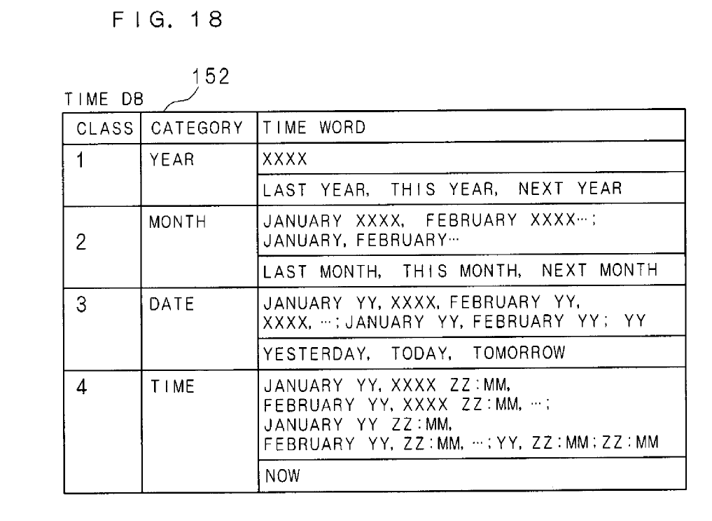

FIG. 18 is an explanatory view illustrating a record layout of the time DB 152. In addition to Embodiment 1, the word indicating time includes words indicating past, present and future. In the class 1, which is the highest class, “last year,” “this year,” “next year” and the like are stored as illustrated in FIG. 18, in addition to “year.” In the class 2, which is a lower class, “last month,” “this month,” “next month” and the like are stored as well as “month.” In the class 3, which is a further lower class, “yesterday,” “today,” “tomorrow” and the like are stored as well as “date.” In the class 4, which is a yet lower class, “now” is stored as well as “time.” The group of words indicating past includes, in the order of class from the lowest, “yesterday,” “last month,” “last year” and the like.

The group of words indicating present includes, in the order of class from the lowest, “now,” “today,” “this month,” “this year” and the like. Similarly, the group of words indicating future includes, in the order of class from the lowest, “tomorrow,” “next month,” “next year” and the like. When executing the unspecifying process on these words indicating time, the CPU 11 converts each word into a word of a higher class in the same group. If the CPU 11 judges that there is a demonstrative pronoun in the message, it multiplies the threshold distance stored in the threshold distance storing file 153, as described in Embodiment 1 or 2, by a coefficient larger than 1 in order to increase the threshold distance, and stores the threshold distance obtained as a result of multiplication in the threshold distance storing file 153. Likewise, if the CPU 11 judges that there is a word indicating past, present or future in the message, it multiplies the threshold time stored in the threshold time storing file 154, as described in Embodiment 1 or 2, by a coefficient larger than 1 in order to increase the threshold time, and stores the threshold time obtained as a result of multiplication in the threshold time storing file 154.

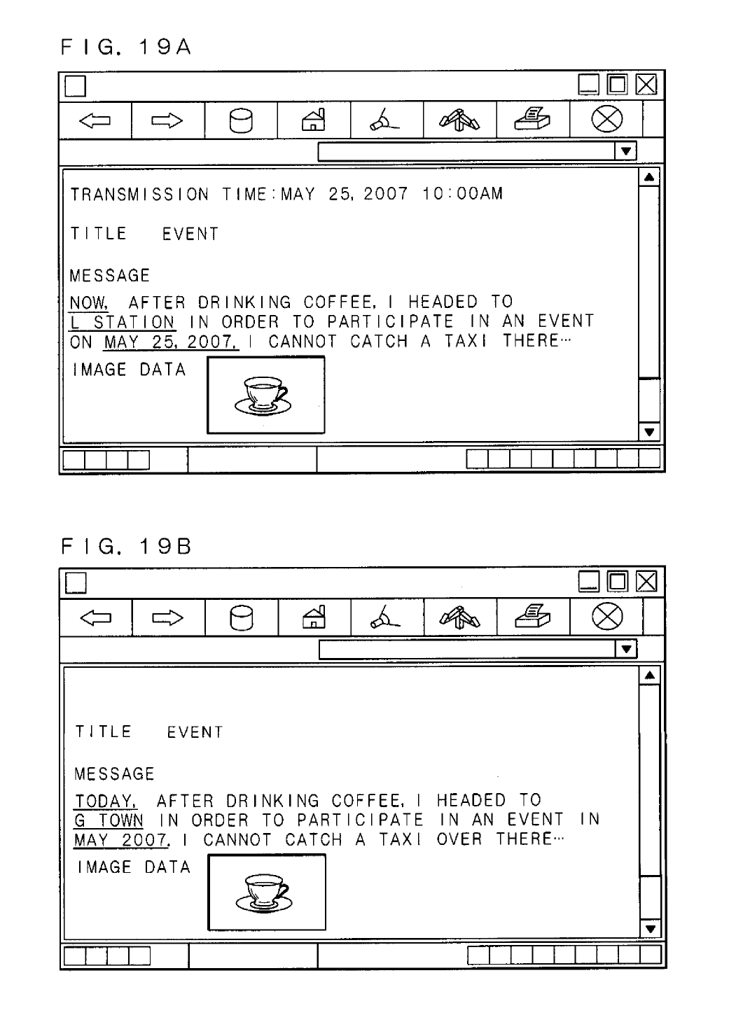

FIGS. 19A and 19B are explanatory views illustrating display images of open information. FIG. 19A is an explanatory view illustrating a display image viewable by a limited user, whereas FIG. 19B is an explanatory view illustrating a display image viewable by a general user. The CPU 11 extracts “now” as a word indicating past, present or future in the message indicated in FIG. 19A with reference to the time DB 152. The CPU 11 then converts the extracted word into “today” of the higher class 3 belonging to the same group as “now” of class 4. The CPU 11 further extracts “there” as a demonstrative pronoun in the message indicated in FIG. 19A with reference to the location DB 151. The CPU 11 then converts the extracted word into “over there” of the higher class 2 belonging to the same group as “there” of class 3. Accordingly, as illustrated in FIG. 19, the message “Now, after drinking coffee, I headed to L station in order to participate in an event on May 25, 2007. I cannot catch a taxi there. . . . ” is converted into “Today, after drinking coffee, I headed to G town in order to participate in an event in May 2007. I cannot catch a taxi over there. . . . ”

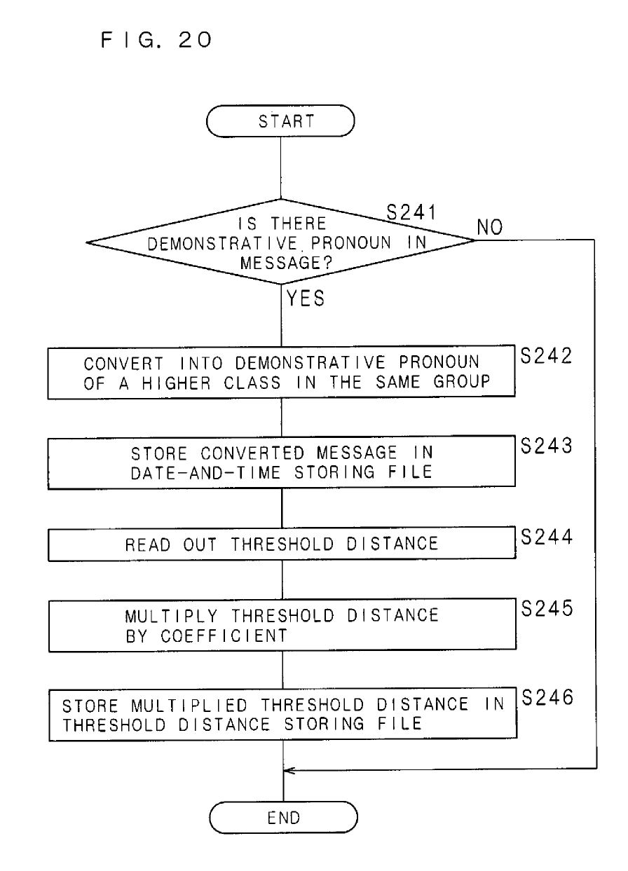

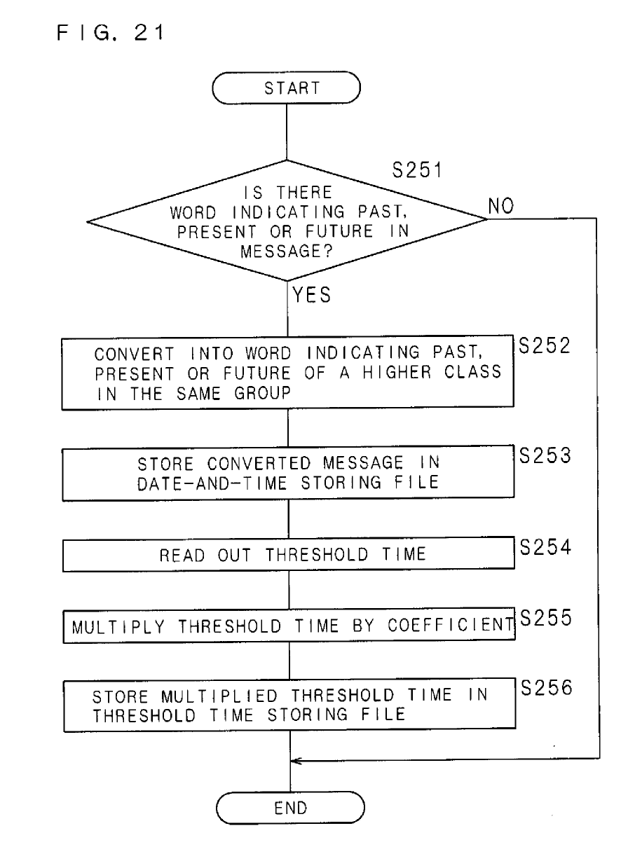

FIG. 20 is a flowchart illustrating the procedure of converting and threshold-distance-increasing processes performed when a demonstrative pronoun is included. The CPU 11 reads out a message stored in the date-and-time storing file 155, and judges whether or not a demonstrative pronoun is included in the read-out message with reference to the location DB 151 (step S241). If the CPU 11 judges that there is no demonstrative pronoun (NO at the step S241), the process is terminated. If, on the other hand, it is judged that there is a demonstrative pronoun (YES at the step S241), the CPU 11 extracts the demonstrative pronoun and converts the extracted demonstrative pronoun into a demonstrative pronoun of a higher class in the same group, with reference to the location DB 151 (step S242). The CPU 11 then stores the converted message in the date-and-time storing file 155 by associating it with the message before conversion (step S243).

Subsequently, the CPU 11 reads out a threshold distance from the threshold distance storing file 153 (step S244), and multiplies the read-out threshold distance by a coefficient larger than 1 stored in the storage unit 15 (step S245). The CPU 11 stores the threshold distance obtained as a result of multiplication in the threshold distance storing file 153 (step S246).

FIG. 21 is a flowchart illustrating the procedure of converting and threshold-time-increasing processes performed when a word indicating past, present or future is included. The CPU 11 reads out a message stored in the date-and-time storing file 155, and judges whether or not a word indicating past, present or future is included in the read-out message with reference to the time DB 152 (step S251). If the CPU 11 judges that there is no word indicating past, present or future (NO at the step S251), the process is terminated. If, on the other hand, it is judged that there is a word indicating past, present or future (YES at the step S251), the CPU 11 extracts the word indicating past, present or future, and converts the extracted word indicating past, present or future into a word indicating past, present or future of a higher class in the same group, with reference to the time DB 152 (step S252). The CPU 11 then stores the converted message in the date-and-time storing file 155 by associating it with the message before conversion (step S253).

Subsequently, the CPU 11 reads out threshold time from the threshold time storing file 154 (step S254), and multiplies the read-out threshold time by a coefficient larger than 1 stored in the storage unit 15 (step S255). The CPU 11 stores the threshold time obtained as a result of multiplication in the threshold time storing file 154 (step S256). When the user enters a demonstrative pronoun or a word indicating past, present or future, he/she may not be conscious of the location or the time zone of his/her activity. In other words, there is a risk that the user may not pay much attention to privacy. According to the processing described above, the threshold distance and threshold time are appropriately increased and unspecified, so that posting of information by the user may be assisted with high security.

Embodiment 3 is as described above, while the other parts are similar to those in Embodiments 1 and 2. Corresponding parts are denoted by the same reference numbers and will not be described in detail.

### Embodiment 4

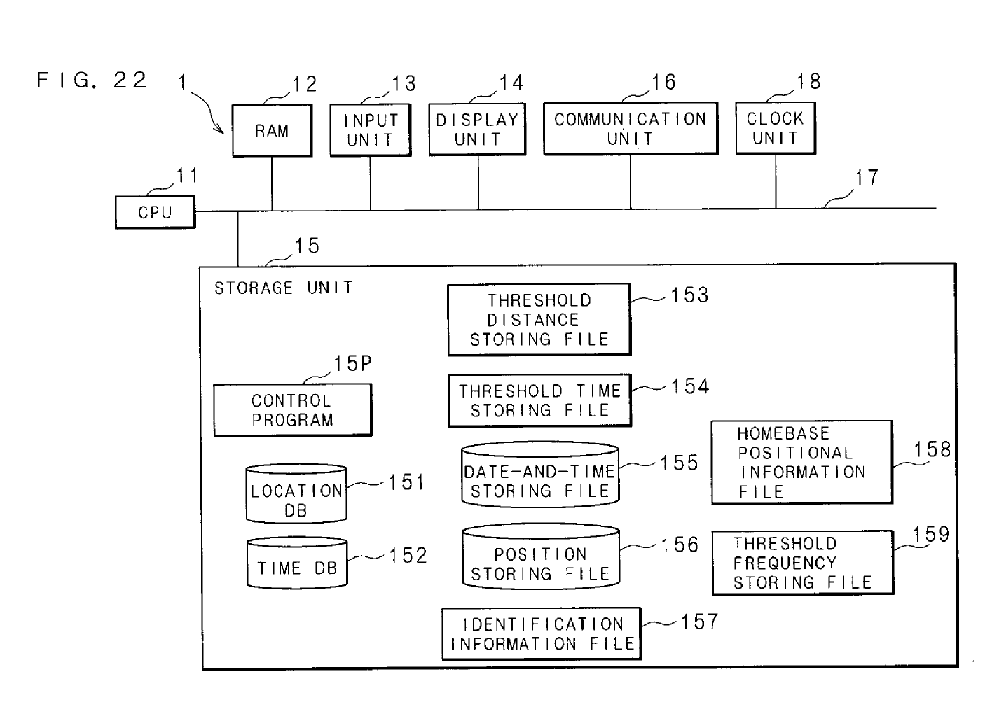

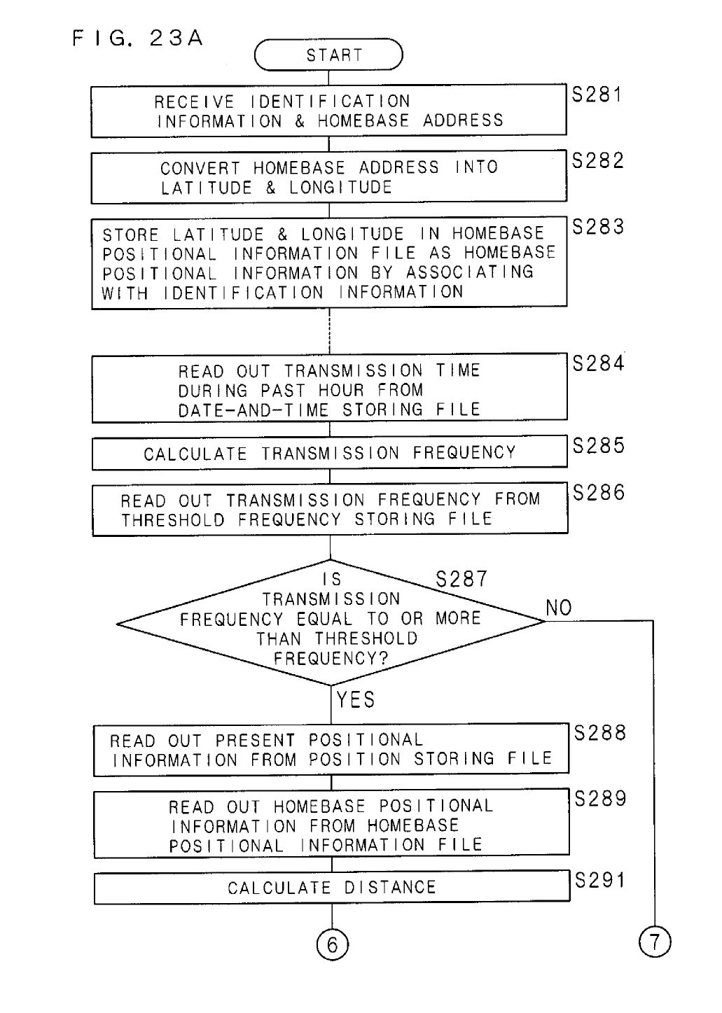

Embodiment 4 relates to an example where threshold time and a threshold distance are shortened in an area other than a homebase. FIG. 22 is a block diagram illustrating hardware of the server computer 1 according to Embodiment 4. In addition to Embodiment 1, a homebase positional information file 158 and a threshold frequency storing file 159 are provided. The homebase positional information file 158 stores therein, for each user, information on a homebase where the user spends a lot of time in a daily life, such as a home or a workplace of each user. More specifically, the user accesses the server computer 1 by the mobile phone 2 to login SNS. Thereafter, the user inputs his/her name and address on an initial registration screen or the like. The input address is transmitted to the server computer 1.

The CPU 11 of the server computer 1 stores the transmitted address by associating it with the user's identification information. Moreover, the CPU 11 reads out map data (not illustrated) from the storage unit 15 to store information on the latitude and longitude corresponding to the transmitted address in the homebase positional information file 158 as homebase positional information by associating it with the user's identification information. The threshold frequency storing file 159 stores therein the transmission frequency of open information transmitted from the mobile phone 2 as a threshold value. For example, “three pieces of information per hour” is stored. The CPU11 refers to a plurality of transmission times in the transmission date-and-time field of the date-and-time storing file 155 to calculate the transmission frequency. In the present Embodiment, the CPU 11 refers to the present date and time information output from the clock unit 18 to calculate how many pieces of open information have been transmitted in the past hour. The CPU 11 then judges whether or not the calculated transmission frequency is equal to or more than threshold frequency stored in the threshold frequency storing file 159.

If the CPU 11 judges that it is equal to or more than the threshold frequency, it reads out the latest positional information among positional information in the position storing file 156, and also reads out the homebase positional information stored in the homebase positional information file 158. The CPU 11 then calculates a distance between the positions based on the both positional information, and judges whether or not the calculated distance is equal to or more than the threshold value stored in the storage unit 15. The threshold distance is stored as, for example, 100 km. If the CPU 11 judges that transmitted frequency is equal to or more than the threshold frequency while the calculated distance is equal to or more than the threshold value, it determines that the user is away travelling and performs a process of shortening the threshold distance stored in the threshold distance storing file 153 and the threshold time stored in the threshold time storing file 154. More specifically, the threshold distance and threshold time are multiplied by a coefficient smaller than 1, e.g. 0.8. Since the user may frequently transmit open information while travelling, the level of privacy protection is somewhat reduced to allow early releasing of newer information.

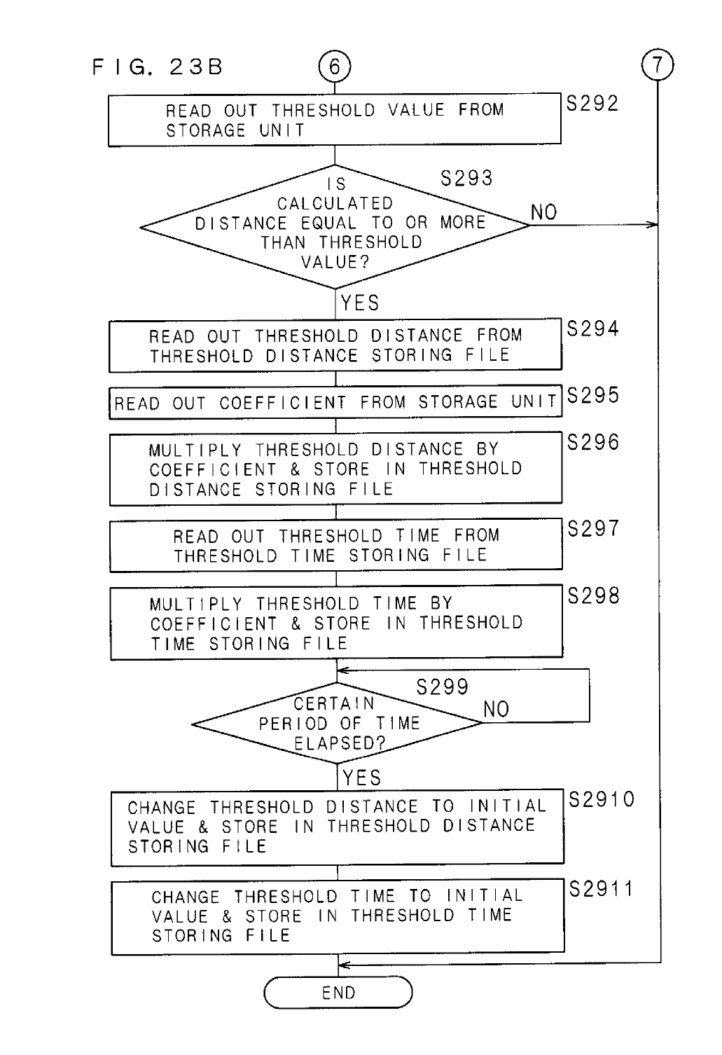

FIGS. 23A and 23B depict a flowchart illustrating the procedure of a shortening process. The CPU 11 of the server computer 1 receives the transmitted identification information for identifying the user as well as the homebase address of the user from the mobile phone 2 (step S281). The CPU 11 refers to the map data stored in the storage unit 15 to convert the received homebase address into the latitude and longitude (step S282). The CPU 11 stores the latitude and longitude obtained after conversion in the homebase positional information file 158 as homebase positional information by associating it with the identification information (step S283).

After the initial registration described above, open information is stored in the date-and-time storing file 155. The CPU 11 refers to the date-and-time information output by the clock unit 18 to read out the transmission times transmitted during the past hour (step S284). The CPU 11 divides the read-out number of transmission times concerning open information by one hour, to calculate the transmission frequency of open information (step S285). The CPU 11 reads out the threshold frequency from the threshold frequency storing file 159 (step S286). The CPU 11 judges whether or not the calculated transmission frequency is equal to or more than the read-out threshold frequency (step S287).

If the CPU 11 judges that the transmission frequency is less than the threshold frequency (NO at the step S287), the series of processes are terminated. If, on the other hand, the CPU 11 judges that the transmission frequency is equal to or more than the threshold frequency (YES at the step S287), the present positional information is read out from the positional storing file 156 (step S288). More specifically, the CPU 11 reads out the positional information with the latest transmission date and time in the position storing file 156. The CPU 11 also reads out the homebase positional information stored at the step S283 from the homebase positional information file 158 (step S289). The CPU 11 calculates a distance between positions based on the positional information read out at the step S288 and the latitude and longitude of the homebase positional information read out at the step S289 (step S291).

The CPU 11 reads out the threshold value from the storage unit 15 (step S292), and judges whether or not the distance calculated at the step S291 is equal to or more than the threshold value (step S293). If the CPU 11 judges that the calculated distance is less than the threshold value (NO at the step S293), the series of processes are terminated. If, on the other hand, the CPU judges that the calculated distance is equal to or more than the threshold value (YES at the step S293), it reads out the threshold distance pre-stored as an initial value from the threshold distance storing file 153 (step S294). The CPU 11 also reads out a coefficient smaller than 1 which is stored in the storage unit 15 in advance (step S295). The CPU 11 then multiplies the threshold distance by the coefficient, and stores the threshold distance obtained as a result of multiplication in the threshold distance storing file 153 (step S296).

Likewise, the CPU 11 reads out the threshold time pre-stored as an initial value from the threshold time storing file 154 (step S297). The CPU 11 multiplies the threshold time by the coefficient smaller than 1 read out at the step S295, and stores the threshold time obtained as a result of multiplication in the threshold time storing file 154 (step S298). Accordingly, the process of shortening the threshold time and threshold distance is executed. The CPU 11 judges whether or not a certain period of time has elapsed (step S299). If it is judged that the certain period of time has not elapsed (NO at the step S299), the CPU 11 waits until the certain period of time has elapsed. Note that the certain period of time is stored in advance in the storage unit 15, which may be e.g. 24 hours.

If the CPU 11 judges that the certain period of time has elapsed (YES at the step S299), it changes the threshold distance to the threshold distance of the initial value read out at the step S294 and stores the changed threshold distance in the threshold distance storing file 153 (step S2910). Likewise, the CPU 11 changes the threshold time to the threshold time of the initial value read out at the step S297 and stores the changed threshold time in the threshold time storing file 154 (step S2911). Accordingly, when the traveling is over, releasing and unspecifying of open information are executed based on the threshold distance and threshold time of the initial values.

Embodiment 4 is as described above, while other parts are similar to those in Embodiments 1 to 3. Thus, corresponding parts are denoted by the same reference numbers and will not be described in detail.

### Embodiment 5

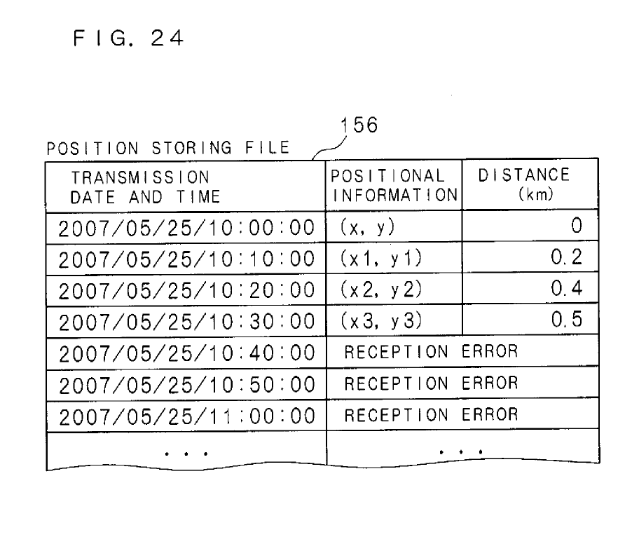

Embodiment 5 relates to an example where the threshold time is increased when positional information has not been received for a certain period of time. FIG. 24 is an explanatory view illustrating a record layout of the position storing file 156 according to Embodiment 2. The CPU 21 of the mobile phone 2 refers to the output of the clock unit 28, and transmits the positional information output from the GPS receiver 212 to the server computer 1 every ten minutes. The CPU 11 of the server computer 1 stores the positional information in the position storing file 156 by associating it with the transmission date and time, as described in Embodiment 1. In the example of FIG. 24, the positional information of the mobile phone 2 is stored every ten minutes.

When the mobile phone 2 is outside the communication network N, when the GPS receiver 212 is not able to receive a GPS signal or when the power is off, however, the positional information may not be transmitted to the server computer 1. In such a case, the CPU 11 of the server computer 1 stores information regarding the fact that the positional information may not be received after ten minutes. In the example of FIG. 24, the positional information which is supposed to be transmitted from the mobile phone 2 at 10:40 is not transmitted. Thus, the CPU 11 stores “reception error,” which is information regarding the fact that the positional information may not be received at 10:40, by associating it with the transmission date and time. Furthermore, the positional information is not received at 10:50 and 11:00.

When a certain period of time has elapsed from the last reception of the positional information, the CPU 11 performs a process of increasing the threshold distance stored in the threshold distance storing file 153. The certain period of time is pre-stored in the storage unit 15, which may be e.g. 30 minutes. When the positional information may not be received, the user might be staying at the same location. Hence, when the positional information may not be received for a certain period of time, the threshold time is increased so as to appropriately protect the user's privacy.

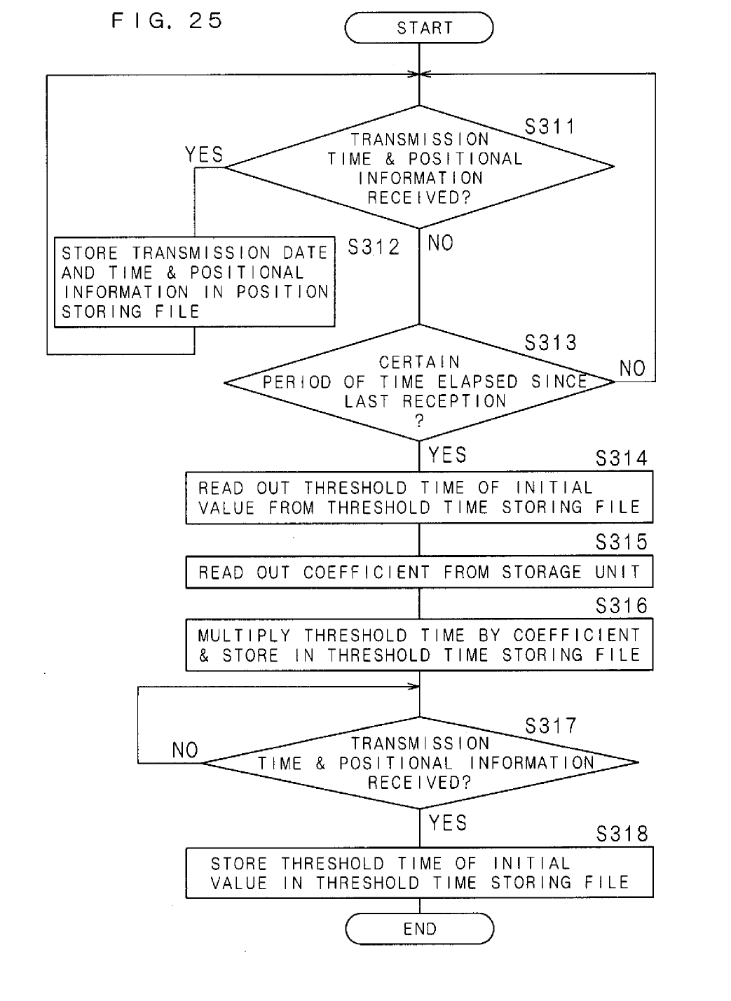

FIG. 25 is a flowchart illustrating the procedure of an increasing process. The CPU 11 judges whether or not the positional information and the transmission date and time are received from the mobile phone 2 (step S311). It is also possible that only the positional information is transmitted from the mobile phone 2, and judgment at the step S311 may be made for whether the positional information is received. In such a case, reception date and time are utilized instead of transmission date and time, with reference to the output by the clock unit 18 in the server computer 1. If the transmission date and time are received as well as the positional information (YES at the step S311), the CPU 11 stores the received transmission date and time as well as the positional information in the position storing file 156 (step S312). Thereafter, the process is returned back to the step S311.

When the positional information and the transmission date and time are not received (NO at the step S311), the CPU 11 judges whether a certain period of time has elapsed since the last reception of the positional information and the transmission date and time with reference to the position storing file 156 (step S313). If it is judged that the certain period of time has not elapsed (NO at the step S313), the CPU 11 returns the process back to S311. If, on the other hand, it is judged that the certain period of time has elapsed (YES at the step S313), the CPU 11 determines that the mobile phone 2 is in an environment where it cannot transmit positional information due to the causes described above, and reads out the threshold time of the initial value stored in the threshold time storing file (step S314).

The CPU 11 reads out a coefficient stored in advance from the storage unit 15 (step S315). Note that the coefficient may be a value larger than 1. The CPU 11 multiplies the threshold time by the coefficient and stores the result in the threshold time storing file 154 (step S316). The CPU 11 judges again whether or not the positional information and the transmission date and time are received (step S317). If the CPU 11 judges that the positional information and the transmission date and time are not received (NO at the step S317), it waits until they are received. If, on the other hand, the CPU 11 judges that the positional information and the transmission date and time are received (YES at the step S317), it changes the threshold time of the initial value pre-stored in the threshold time storing file to the threshold time obtained after multiplication by the coefficient, which is stored at the step S316, and store the changed threshold time (step S318).

Embodiment 5 is as described above, while the other parts are similar to those in Embodiments 1 to 4. Thus, corresponding parts are denoted by the same reference numbers and will not be described in detail.

### Embodiment 6

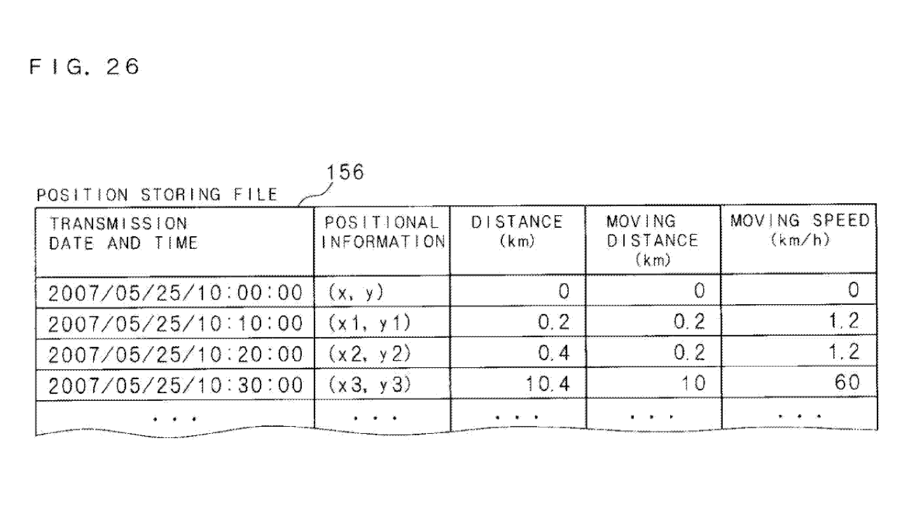

Embodiment 6 relates to an example where the threshold time and threshold distance are shortened in accordance with the moving speed of the mobile phone 2. FIG. 26 is an explanatory view illustrating the record layout of the position storing file 156 according to Embodiment 6. In addition to Embodiment 1, a moving distance field and a moving speed field are newly provided. The position storing file 156 serves as a position history DB. As described in Embodiment 1, the CPU 21 of the mobile phone 2 transmits the positional information and the transmission date and time to the server computer 1, while the CPU 11 of the server computer 1 receives the positional information and the transmission date and time. The distance field stores therein the distance between the positional information of the mobile phone 2 at the time point where the transmission date and time are first received, and the positional information after a unit of time (ten minutes in the present example) has elapsed, by associating it with the transmitted positional information.

The CPU 11 calculates the moving distance per unit of time based on the distance stored in the distance filed, and stores the calculated distance in the moving distance field by associating it with the positional information and the transmission date and time. For example, at 10:10 on May 25, it may be understood that the position has been moved by 0.2 km compared to 10:00 which is ten minutes ago. Moreover, at 10:20, it has been moved by 0.2 km compared to 10:10 which is ten minutes ago. Likewise, at 10:30, the position has been moved by 10 km compared to 10:20 which is ten minutes ago.

The CPU 11 further calculates the moving speed per unit of time based on the moving distance per unit of time, and stores the calculated moving speed in the moving speed field of the position storing file 156. In the present example, the unit of “per hour” is employed for storing. As for the time period from 10:00 to 10:10, and from 10:10 to 10:20, each moving distance is 0.2 km, so that the speed is calculated as 1.2 km per hour. Here, it is estimated that the user carrying the mobile phone 2 is moving by foot. On the other hand, from 10:20 to 10:30, the position is moved 10 km in ten minutes, so that the moving speed is calculated as 60 km per hour.

Here, it is estimated that the user of the mobile phone 2 is moving by a train or a car. The CPU 11 reads out the threshold moving speed pre-stored in the storage unit 15. When the moving speed is equal to or more than the threshold moving speed, the CPU 11 determines that the mobile phone 2 is moving by a train or a car. In such a case, the mobile phone 2 is getting away at a high speed from the position where the user transmits open information, so that the privacy of the user may still be sufficiently protected even if the threshold distance and threshold time are shortened. The CPU 11 performs a process of shortening the threshold time stored in the threshold time storing file 154, and also performs a process of shortening the threshold distance stored in the threshold distance storing file 153 as well.

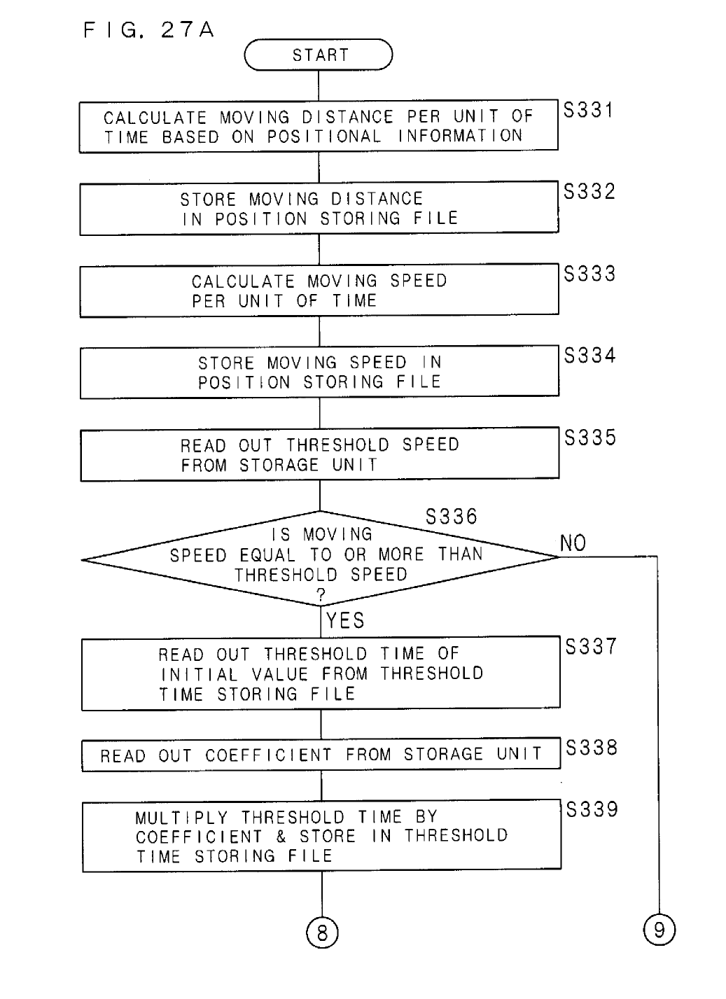

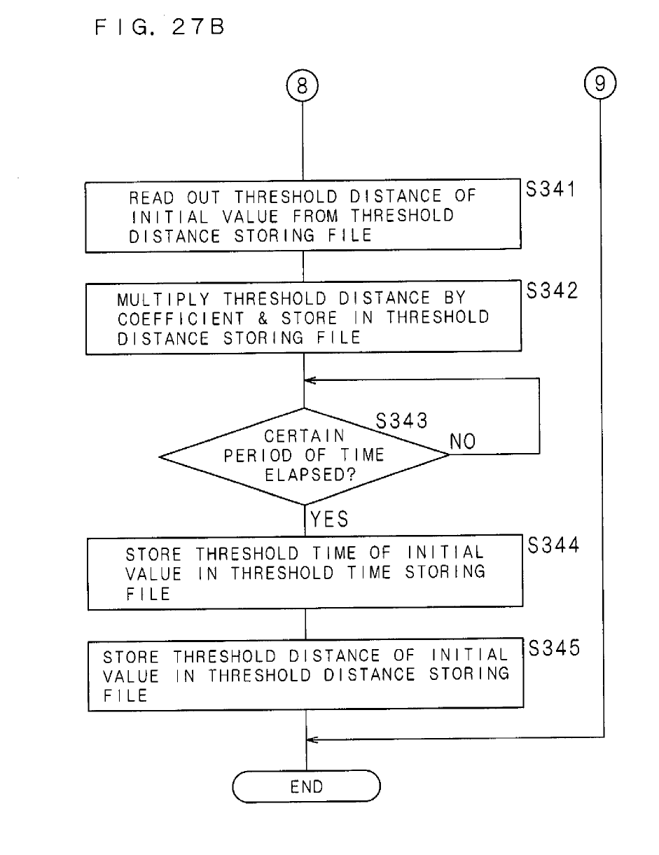

FIGS. 27A and 27B depict a flow chart illustrating the procedure of shortening process for threshold time and threshold distance based on moving speed. The CPU 11 of the server computer 1 sequentially stores the positional information transmitted from the mobile phone 2 every unit of time in the position storing file 156, by associating it with the transmission date and time. The CPU 11 calculates the moving distance per unit of time based on the transmitted positional information (step S331). The CPU 11 stores the calculated moving distance in the position storing file 156 by associating it with the transmission date and time (step S332). The CPU 11 calculates the moving speed per unit of time based on the calculated moving distance and the unit of time (step S333).

The CPU 11 stores the calculated moving speed in the position storing file 156 by associating it with the moving distance and the transmission date and time (step S334). The CPU 11 reads out the threshold speed stored in advance in the storage unit 15 (step S335). The CPU 11 judges whether or not the calculated moving speed is equal to or more than the threshold speed (step S336). If the CPU 11 judges that the calculated moving speed is less than the threshold speed (NO at the step S336), the series of processes are terminated. If, on the other hand, the CPU 11 judges that the calculated moving speed is equal to or more than the threshold speed (YES at the step S336), it reads out the threshold time of the initial value from the threshold time storing file 154 (step S337).

The CPU 11 then reads out a coefficient from the storage unit 15 (step S338), multiplies the threshold time by the read-out coefficient, and stores the threshold time obtained as a result of multiplication in the threshold time storing file 154 (step S339). Note that the coefficient may be a value smaller than 1. Likewise, the CPU 11 reads out the threshold distance of the initial value stored in the threshold distance storing file 153 (step S341). The CPU 11 multiplies the read-out threshold distance by the coefficient read out at the step S338, and stores the threshold distance obtained as a result of multiplication in the threshold distance storing file 153 (step S342).

The CPU 11 judges whether or not a certain period of time has elapsed (step S343). If the CPU 11 judges that the certain period of time has not elapsed (NO at the step S343), it waits until the certain period of time elapses. The certain period of time is stored in the storage unit 15 as, for example, three hours. If, on the other hand, the CPU 11 judges that a certain period of time has elapsed (YES at the step S343), it stores the threshold time of the initial value in the threshold time storing file 154 (step S344) while it stores the threshold distance of the initial value in the threshold distance storing file 153 (step S345), so as to bring the threshold distance and threshold time to the initial values.

Embodiment 6 is as described above, while the other parts are similar to those in Embodiments 1 to 5. Hence, corresponding parts are denoted by the same reference numbers and will not be described in detail.

### Embodiment 7

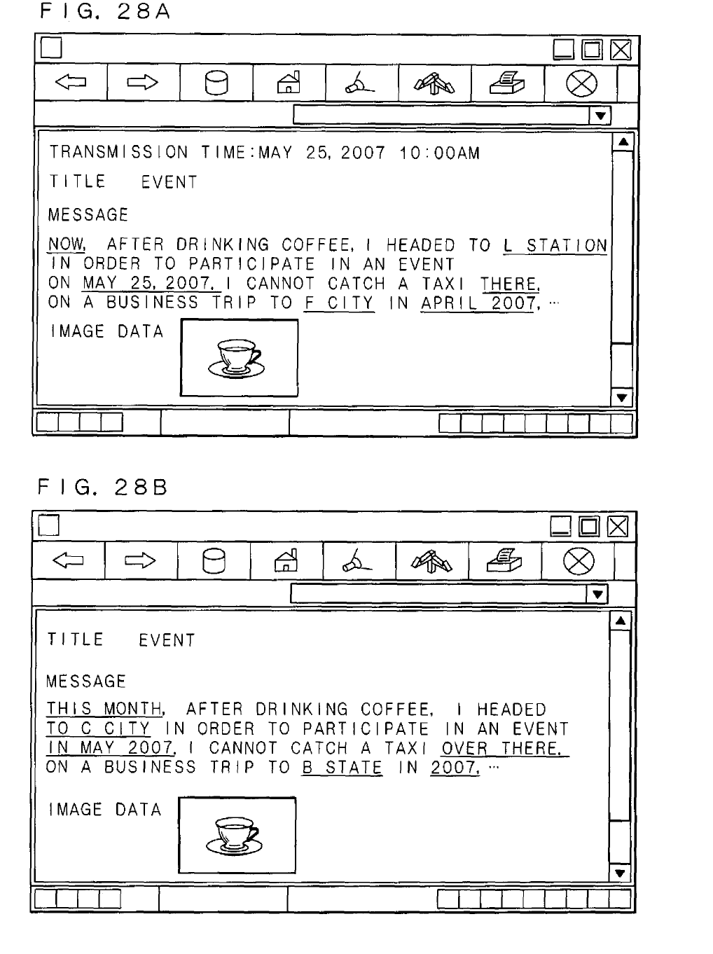

Embodiment 7 relates to an example in which, when there are a plurality of words indicating time and words indicating locations belonging to different classes, a word other than the word belonging to the highest class is converted into a word corresponding to the highest class. FIGS. 28A and 28B are explanatory views illustrating display images of open information. FIG. 28A is an explanatory view illustrating a display image viewable by a limited user, whereas FIG. 28B is an explanatory view illustrating a display image viewable by a general user. The processing performed in the present Embodiment will be described using the example sentences in FIG. 28.

The CPU 11 extracts a word indicating a location included in the message with reference to the location DB 151 illustrated in FIG. 17. In the example of FIG. 28A, “L station” of class 4, “there” of class 3 and “F city” of class 2 are extracted. The CPU 11 extracts the word indicating a location of the highest class in the message, and performs a process of converting another word indicating a location such that the word corresponds to the class of the extracted word indicating a location. Moreover, the word indicating a location of the highest class in the message is converted into a word indicating a location belonging to an even higher class by the process described in Embodiment 1. For example, “L station” of class 4 is converted into “C city” of class 2, skipping “G town” of class 3. This is because it is safer to execute the converting process based on a class as high as possible when there are a plurality of classes.

Moreover, “there” of class 3 is converted into “over there” which is a pronoun indicating a distant object of class 2. “F city” of class 2, the highest in the sentence, is converted into “B state” belonging to class 1 which is one class higher. Similar processing is performed for a word indicating time. The CPU 11 extracts a word indicating time included in the message with reference to the time DB 152 illustrated in FIG. 18. In the example of FIG. 28A, “now” of class 4, “May 25, 2007” of class 3 and “April 2007” of class 2 are extracted. The CPU 11 extracts a word indicating time belonging to the highest class, and converts another word indicating time such that the word corresponds to the class of the extracted word indicating time. Moreover, the word indicating time of the highest class in the sentence is converted into a word indicating time belonging to an even higher class by the process described in Embodiment 1.

For example, “now” of class 4 is converted into “this month” of class 2, skipping “today” of class 3. Moreover, “May 25, 2007” of class 3 is converted into “May 2007” of class 2. Furthermore, “April 2007” of class 2, the highest class in the message, is converted into “2007” belonging to class 1 which is one class higher. When the class is the highest class of class 1 and there is no higher class, the CPU 11 may delete the word indicating a location or time, or convert it into a specific symbol, such as a question mark, a “secret” mark or the like. The CPU 11 stores the converted message in the date-and-time storing file 155 together with the message before conversion. When there is no higher class, it is often unnecessary to raise a class because security and privacy protection is sufficient. In such a case, there is no need to convert a word into a specific symbol.

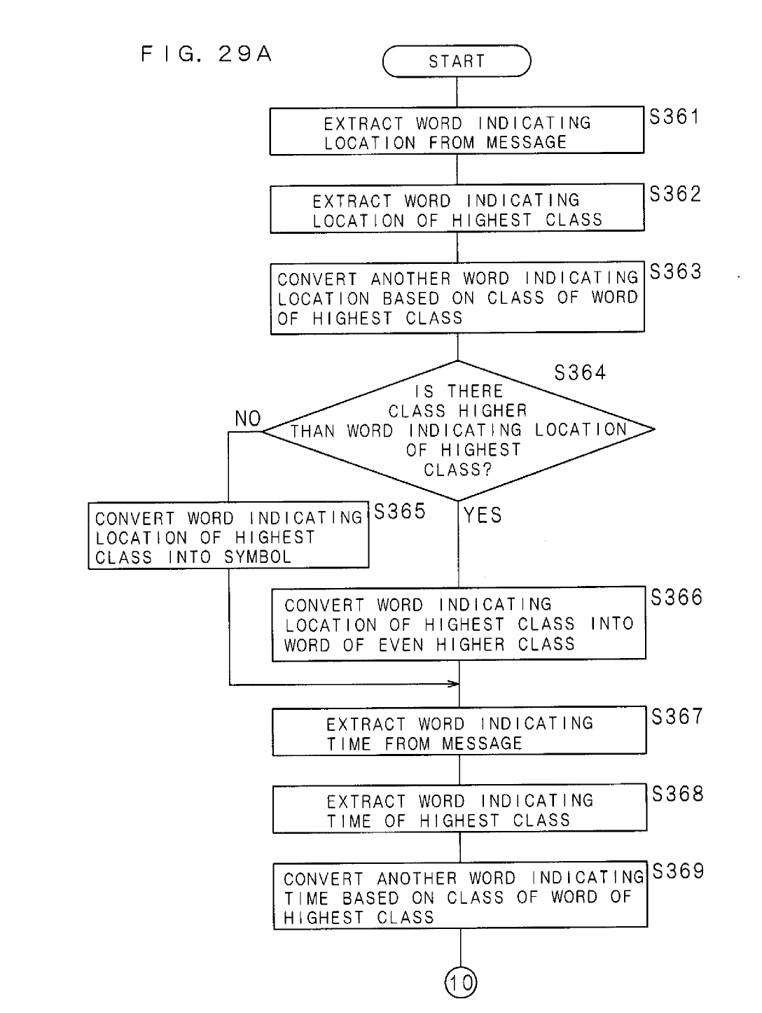

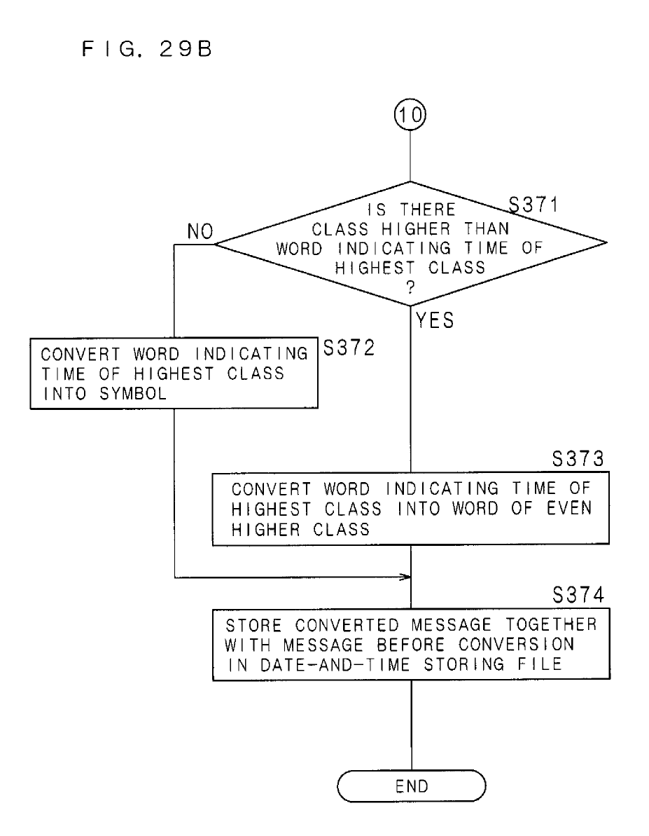

FIGS. 29A and 29B depict a flow chart illustrating the procedure of a converting process. The CPU 11 reads out the transmitted message from the date-and-time storing file 155, and performs a converting process in accordance with the procedure described below. The CPU 11 extracts a word indicating a location from the read-out message with reference to the location DB 151 (step S361). The CPU 11 looks at the classes of the extracted words indicating locations to extract a word indicating a location of the highest class in the message (step S362). The CPU 11 converts another word indicating a location which was not extracted at the step S362 into a word corresponding to the highest class with reference to the location DB 151 (step S363).

The CPU 11 judges whether or not there is a class even higher than the class of the word indicating a location of the highest class in the message with reference to the location DB 151 (step S364). If it is judged that there is no more higher class (NO at the step S364), the CPU 11 converts the extracted word indicating a location of the highest class into an abstract symbol stored in the storage unit 15 in advance (step S365). If, on the other hand, the CPU 11 judges that there is a higher class (YES at the step S364), it converts the word indicating a location of the highest class in the message into a word of an even higher class (step S366).

The CPU 11 extracts a word indicating time from the read-out message with reference to the time DB 152 (step S367). The CPU 11 looks at the class of the extracted word indicating time, and extracts a word indicating time of the highest class in the message (step S368). The CPU 11 converts another word indicating time which has not been extracted at the step S367 into a word corresponding to the highest class in the message with reference to the time DB 152 (step S369).

The CPU 11 judges whether or not there is a class higher than that of the word indicating time of the highest class in the message with reference to the time DB 152 (step S371). If it is judged that there is no more higher class (NO at the step S371), the CPU 11 converts the word indicating time of the highest class which has been extracted at the step S368 into an abstract symbol pre-stored in the storage unit 15 (step S372). If, on the other hand it is judged that there is a higher class (YES at the step S371), the CPU 11 converts the word indicating time of the highest class in the message into the word of an even higher class (step S373). The CPU 11 then stores the converted message in the date-and-time storing file 155 by associating it with the message before conversion (step S374).

Embodiment 7 is as described above, while the other parts are similar to those in Embodiments 1 to 6. Hence, the corresponding parts are denoted by the same reference numbers and will not be described in detail.

### Embodiment 8

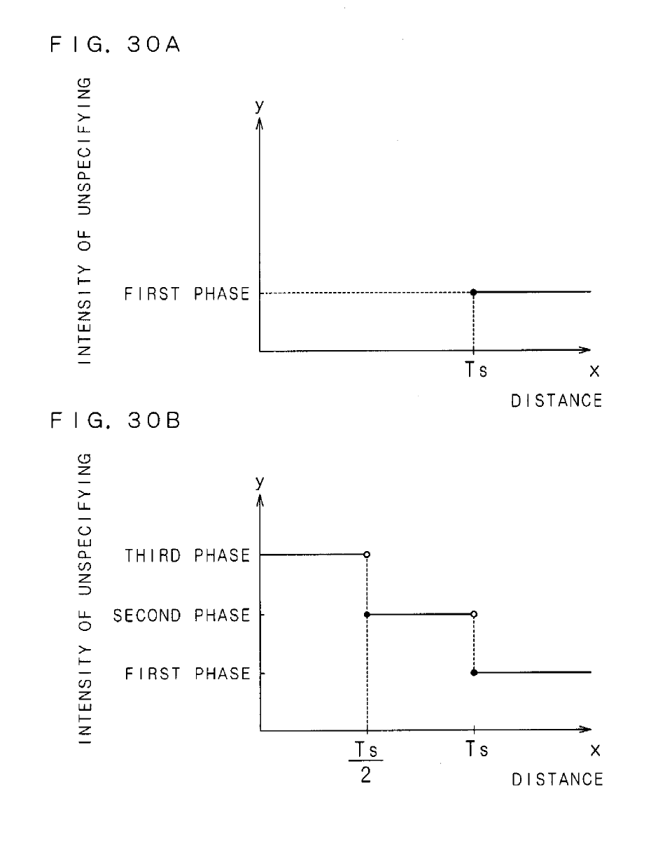

Embodiment 8 relates to an example where a more intense unspecifying process is performed before transmitting converted open information to a general user, when the distance between the position at which information is transmitted and the present position is less than the threshold distance and the time difference between the transmission time and the present time is less than the threshold time. FIGS. 30A and 30B are graphic charts for explaining processing contents of the present Embodiment. FIG. 30A is a graph illustrating the change in the unspecifying intensity of open information for a general user according to Embodiment 1, whereas FIG. 30B is a graph illustrating the change in the unspecifying intensity of open information for a general user according to the present Embodiment. The horizontal axis indicates the distance, Ts being the threshold distance. The vertical axis indicates the intensity of the unspecifying process. Both FIGS. 30A and 30B indicate the change in the intensity of unspecifying associated with the change in the distance.

As illustrated in FIG. 30A, in Embodiment 1, the open information converted by the unspecifying process is transmitted to a general user when the distance between positions is equal to or more than the threshold distance. In the example of FIG. 30A, the intensity of unspecifying is in the first phase. The first phase corresponds to a converting process in which the class of a word indicating location is raised by one phase. When it is less than the threshold distance, a general user is not able to receive the transmission of the converted message. Same applies to the threshold time. A limited user is, on the other hand, able to receive the transmission of unspecified open information.

In the present Embodiment, the open information is transmitted to a general user even when it is less than the threshold distance, by further increasing the intensity of unspecifying. When the distance between positions is equal to or more than a half the threshold distance and less than the threshold distance, the CPU 11 performs the unspecifying process with the intensity of the second phase, which is one phase higher than the first phase. More specifically, the CPU 11 performs the converting process in which the class of a word indicating distance is raised by two phases. Moreover, when the distance is less than a half the threshold distance, the CPU 11 performs the unspecifying process with the third phase which is two phases higher than the first phase. More specifically, the CPU 11 performs the converting process in which the class of a word indicating distance is raised by three phases. Accordingly, information with high immediacy may be provided to a general user while protecting the information-transmitting user's privacy. Though the intensity is changed on the basis of a half the threshold distance in the present Embodiment, it is merely an example. The intensity may freely be changed, for example, on the basis of every third of the threshold distance.

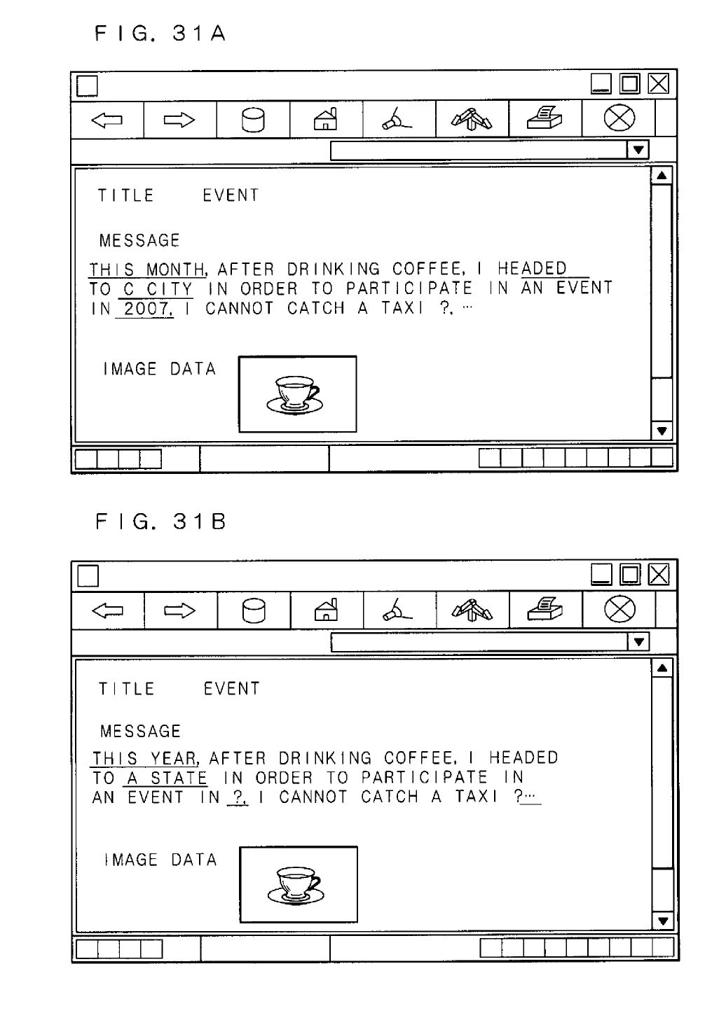

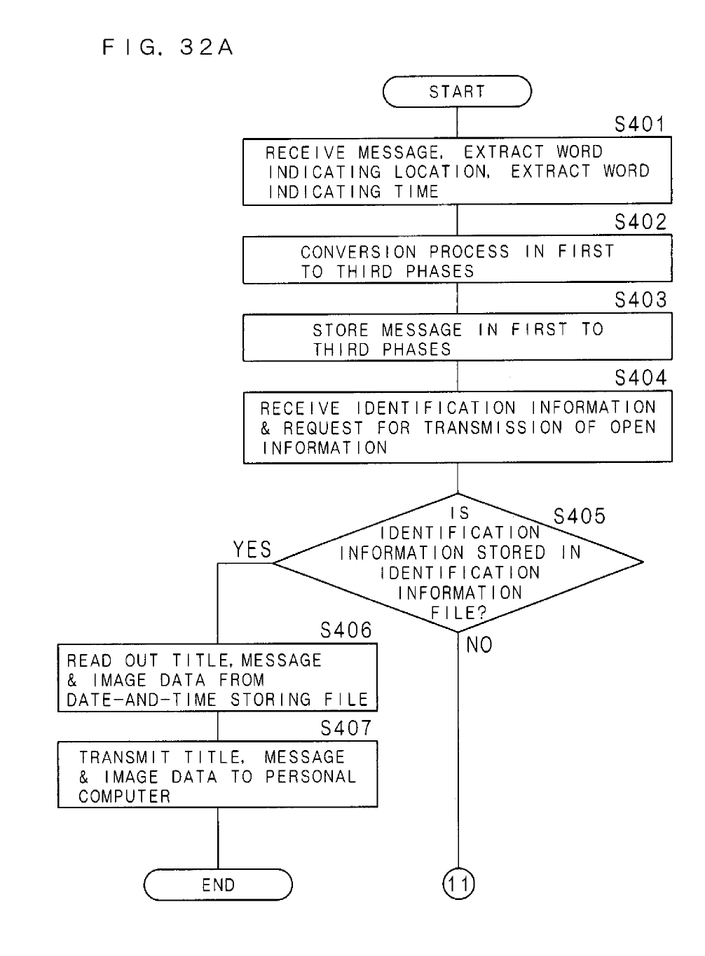

FIGS. 31A and 31B are explanatory views illustrating display images of open information. FIG. 31A is an explanatory view of a display image viewable by a general user when the unspecifying intensity is in the second phase, whereas FIG. 31B is an explanatory view of a display image viewable by a general user when the unspecifying intensity is in the third phase. The display image viewable by a limited user is as illustrated in FIG. 19A, while the display image viewable by a general user when the unspecifying intensity is in the first phase is as illustrated in FIG. 19B.

The example of FIG. 31B illustrates the case where the distance is less than a half the threshold distance, or the time difference is less than a half the threshold time. Here, the CPU 11 performs a converting process in which the unspecifying intensity is raised from the original class of a word indicating time or location by three phases. For example, the word “now” indicating time is raised by three phases and converted into “this year.” Likewise, the word “L station” indicating a location is raised by three phases and converted into “A state.” If there is no corresponding word in the location DB151 or the time DB 152 when the class is raised, the CPU 11 converts the word into the symbol “?” read out from the storage unit 15. For example, the word indicating time “May 25, 2007” is converted into “?,” while the word indicating a location “there” is also converted into “?.”

The example of FIG. 31A illustrates the case where the distance is equal to or more than a half the threshold distance and less than the threshold distance, or the time difference is equal to or more than a half the threshold time and less than the threshold time. Here, the CPU 11 performs a converting process in which the unspecifying intensity is raised from the original class of the word indicating time or a location by two phases. For example, the word “now” indicating time is raised by two phases and converted into “this month.” Likewise, the word “L station” indicating a location is raised by two phases and converted into “C city.” Accordingly, information with higher immediacy may be provided also to a general user. As for limited users, classes of two phases may be provided. For a limited user in one class, the open information obtained after the unspecifying process according to the present Embodiment may be transmitted when the distance is less than the threshold distance and the time difference is less than the threshold time, as with the general users.

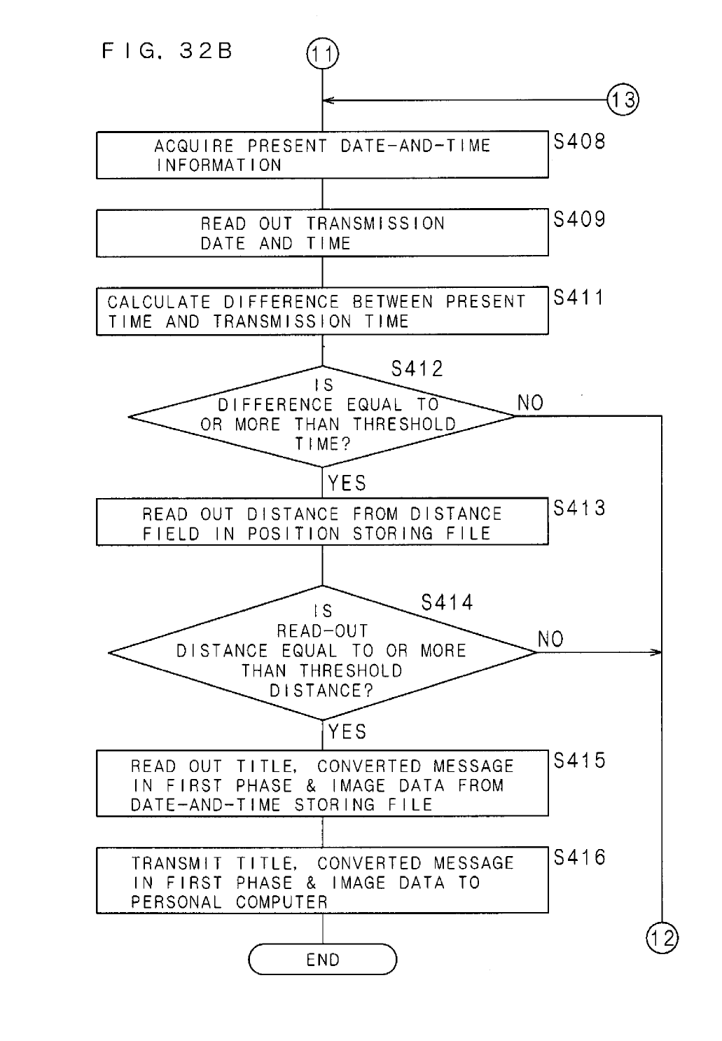

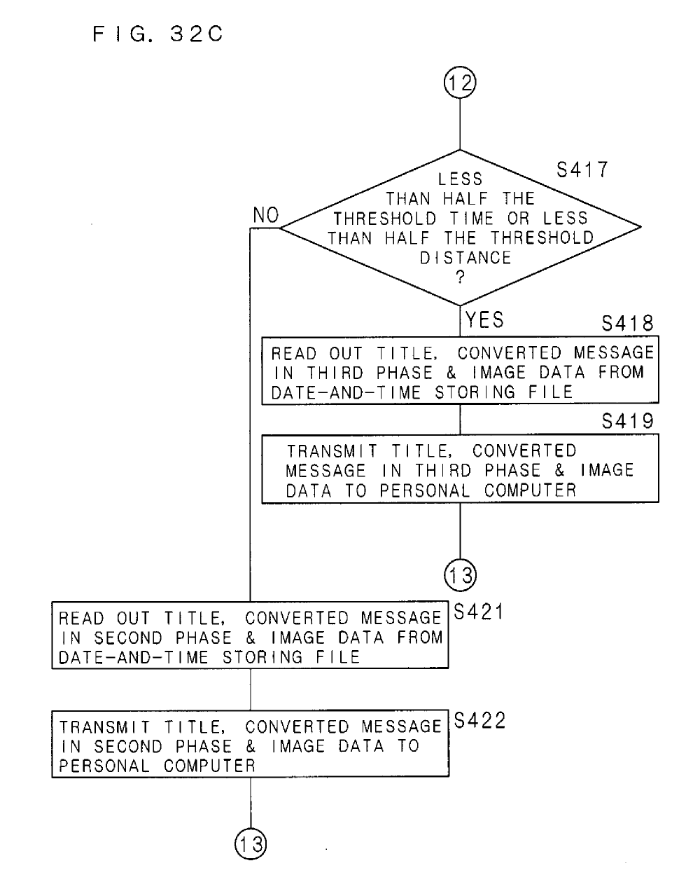

FIGS. 32A to C depict a flowchart illustrating the procedures of the converting process and the transmitting process. The CPU 11 of the server computer 1 receives a message in the open information transmitted from the mobile phone 2 and extracts a word indicating a location and a word indicating time (step S401). The CPU 11 performs the converting process from the first to the third phases on the extracted word indicating a location with reference to the location DB 151, whereas it performs the converting process from the first to the third phases on the extracted word indicating time with reference to the time DB 152 (step S402). The CPU 11 then stores the message obtained after the converting process from the first to the third phases in the date-and-time storing file 155 by associating it with the message before conversion (step S403). More specifically, based on the class of the extracted word indicating a location, the CPU 11 reads out a corresponding word indicating a location belonging to a class higher by one class and converts the extracted word as the first phase, reads out a corresponding word indicating a location belonging to a class higher by two classes and converts the extracted word as the second phase, and reads out a corresponding word indicating a location belonging to a class higher by three classes and converts the extracted word as the third phase. Similar processing is performed for a word indicating time.

Thereafter, a general user or a limited user who wishes to view the released open information, he/she boots up the browser of the personal computer 3 to access the server computer 1. The CPU 11 of the server computer 1 transmits a screen for logging in SNS. The general or limited user inputs an identification number to login. The CPU 11 of the server computer 1 receives a request for transmission of open information and the identification information transmitted from the personal computer 3 (step S404).

The CPU 11 judges whether or not the transmitted identification information concerning the user, to which the open information is to be released, is stored in the identification information file 157 (step S405). The CPU 11 refers to the identification information file 157 to judge whether or not the transmitted identification information is stored as identification information concerning the user to which the open information is to be released.

If it is judged that the transmitted identification information is stored in the identification information file 157 as the identification information concerning the user to which the open information is to be released (YES at the step S405), the CPU 11 determines that the user of the personal computer 3 is a limited user, and reads out the title, message and image data from the date-and-time storing file 155 (step S406). The CPU 11 then converts the title, message and image data into an HTML document and transmits it to the personal computer 3 of the limited user (step S407). Then, the process is terminated.

If, on the other hand, it is judged that the transmitted identification information is not stored in the identification information file 157 as the identification information concerning the user to which the open information is to be released (NO at the step S405), the CPU 11 determines that the user of the personal computer 3 is a general user, and acquires the present date-and-time information with reference to the output of the clock unit 18 (step S408). The CPU 11 reads out the transmission date and time stored in the date-and-time storing file 155 (step S409). The CPU 11 calculates the difference between the present date-and-time information acquired at the step S408 and the transmission date and time read out at the step S409 (step S411).

The CPU 11 judges whether or not the calculated difference is equal to or more than the threshold time stored in the threshold time storing file 154 (step S412). If it is judged that the difference is equal to or more than the threshold time (YES at the step S412), the CPU 11 reads out a distance from the distance field in the position storing file 156 (step S413).

The CPU 11 judges whether or not the read-out distance is equal to or more than the threshold distance stored in the threshold distance storing file 153 (step S414). If it is judged that the read-out distance is equal to or more than the threshold distance (YES at the step S414), the CPU 11 reads out the title, the converted message obtained after the unspecifying process and the image data from the date-and-time storing file 155 (step S415). The CPU 11 then converts the title, the converted message and the image data into an HTML document, and transmits it to the personal computer 3 of the general user (step S416). Then the series of processes are terminated. If the CPU 11 judges that the difference is less than the threshold time at the step S412 (NO at the step S412) and that the distance is less than the threshold distance at the step S414 (NO at the step S414), it judges whether or not the difference is less than a half the threshold time or the distance is less than a half the threshold distance (step S417).

If the CPU 11 judges that the difference is less than a half the threshold time or that the distance is less than a half the threshold distance (YES at the step S417), it reads out the title, the converted message in the third phase and the image data from the date-and-time storing file 155 so as to allow releasing in the third phase (step S418). The CPU 11 then transmits the title, the converted message in the third phase and the image data to the personal computer 3 of the general user (step S419). The CPU 11 returns the process back to the step S408.

If the CPU 11 judges that the difference is not less than a half the threshold time or the distance is not less than a half the threshold distance (NO at the step S417), it determines that the difference is equal to or more than a half the threshold time and less than the threshold time, or that the distance is equal to or more than a half the threshold distance and less than the threshold distance, and reads out the title, the converted message in the second phase and the image data from the date-and-time storing file 155 so as to allow releasing in the second phase (step S421). The CPU 11 then transmits the title, the converted message in the second phase and the image data to the personal computer 3 of the general user (step S422). Then, the CPU 11 returns the process back to the step S408.

Embodiment 8 is as described above, while the other parts are similar to those in Embodiments 1 to 7. Thus, the corresponding parts are denoted by the same reference numbers and will not be described in detail.

### Embodiment 9

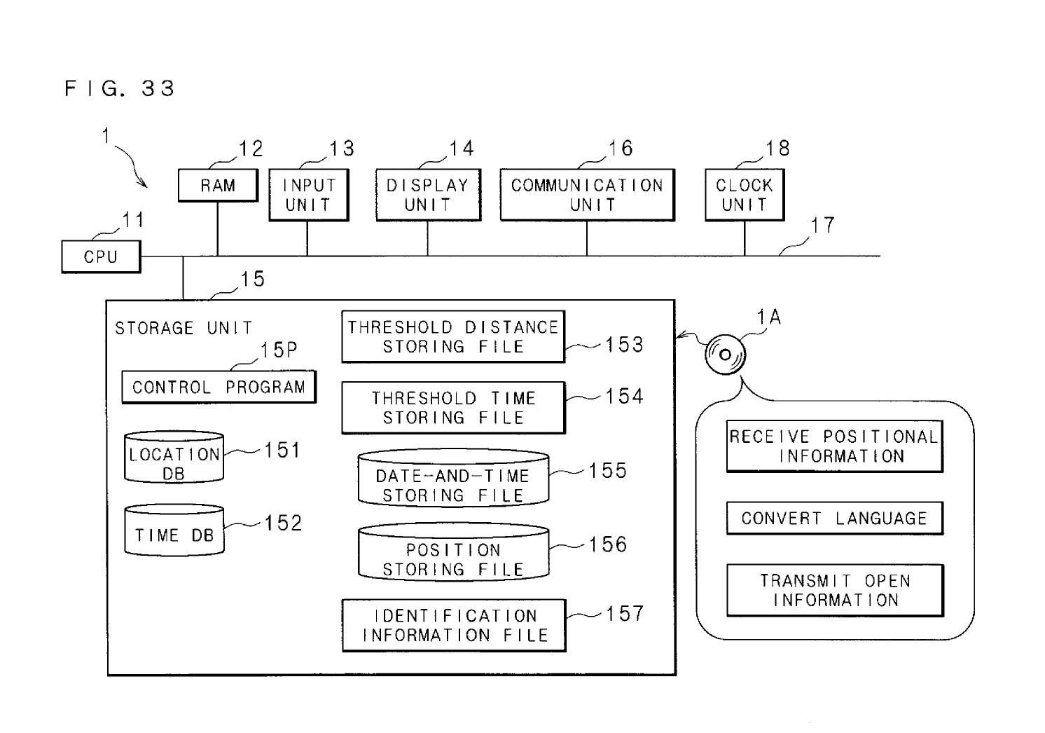

FIG. 33 is a block diagram illustrating the hardware of the server computer 1 according to Embodiment 9. The program for operating the server computer 1 according to Embodiment 9 may also be provided as a portable recording medium 1A such as a CD-ROM as described in Embodiment 9. Moreover, the program may be downloaded from another server computer (not illustrated) via the communication network N. This will be described below in detail.

The portable recording medium 1A, in which a program for making a recording medium reading device (not illustrated) of the server computer 1 receive positional information, convert a word and transmit open information is recorded, is inserted so as to install the program into the control program 15P in the storage unit 15. Alternatively, such a program may be downloaded from another external server computer (not illustrated) via the communication unit 16 to be installed into the storage unit 15. The program is loaded to RAM 12 to be executed. Accordingly, the server computer 1 functions as described above.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An open information transmitting method transmitting open information, transmitted from a mobile information terminal to a central device so as to be released to a third party, from said central device to an information processing terminal, comprising:
receiving, by said central device including a processor, positional information transmitted from said mobile information terminal;
converting, by said processor, a word indicating a location included in the open information transmitted from said mobile information terminal into a word indicating a location belonging to a higher class, with reference to a location database in which words indicating locations are classified in accordance with a plurality of classes; and
transmitting, by said processor, the converted open information from said central device to said information processing terminal when a distance between positions based on the received positional information of said mobile information terminal and positional information of said mobile information terminal obtained when said open information is transmitted is equal to or more than a threshold distance stored in a storage unit.

2. An open information transmitting system including a mobile information terminal, an information processing terminal and a central device connected with one another via a communication network, wherein
said mobile information terminal includes a terminal transmission unit transmitting to said central device open information to be released to a third party, and
said central device includes
an open information receiving unit receiving the open information transmitted from said terminal transmission unit,
a reception unit receiving positional information transmitted from said mobile information terminal,
conversion unit converting a word indicating a location included in the open information transmitted from said mobile information terminal into a word indicating a location belonging to a higher class, with reference to a location database in which words indicating locations are classified in accordance with a plurality of classes, and
a transmission unit transmitting open information obtained as a result of conversion by said conversion unit to said information processing terminal when a distance between positions based on positional information of said mobile information terminal received by said reception unit and positional information of said mobile information terminal at a time point where said open information is transmitted is equal to or more than a threshold distance stored in a storage unit.

3. A central device transmitting to the outside open information transmitted from a mobile information terminal so as to be released to a third party, comprising:
a reception unit receiving positional information transmitted from said mobile information terminal;
a conversion unit converting a word indicating a location included in the open information transmitted from said mobile information terminal into a word indicating a location belonging to a higher class with reference to a location database in which words indicating locations are classified in accordance with a plurality of classes; and
a transmission unit transmitting open information obtained as a result of conversion by said conversion unit to the outside, when a distance between positions based on positional information of said mobile information terminal received by said reception unit and positional information of said mobile information terminal at a time point where said open information is transmitted is equal to or more than a threshold distance stored in a storage unit.

4. The central device according to claim 3, further comprising:
a date-and-time storing unit storing a transmission date and time at which said open information is transmitted form said mobile information terminal; and
a time conversion unit converting a word indicating time included in the open information transmitted from said mobile information terminal into a word indicating time belonging to a higher class with reference to a time database in which words indicating time are classified in accordance with a plurality of classes, wherein
said transmission unit transmits to the outside open information obtained as a result of conversion by said conversion unit and said time conversion unit, when a distance between positions based on positional information of said mobile information terminal received by said reception unit and positional information of said mobile information terminal at a time point where said open information is transmitted is equal to or more than a threshold distance stored in a storage unit, and when a difference between time output by a clock unit and transmission time stored in said date-and-time storing unit is equal to or more than threshold time stored in said storage unit.

5. The central device according to claim 4, further comprising a threshold distance increasing unit increasing the threshold distance stored in said storage unit when there is a word indicating a location included in the open information transmitted from said mobile information terminal.

6. The central device according to claim 4, further comprising a threshold time increasing unit increasing the threshold time stored in said storage unit when there is a word indicating time included in the open information transmitted from said mobile information terminal.

7. The central device according to claim 5, wherein
said word indicating a location includes a demonstrative pronoun, and
said threshold distance increasing unit increases the threshold distance stored in said storage unit when a demonstrative pronoun is included in the open information transmitted from said mobile information terminal.

8. The central device according to claim 6, wherein
said word indicating time includes a word indicating past, present or future, and
said threshold time increasing unit increases the threshold time stored in said storage unit when a word indicating past, present or future is included in the open information transmitted form said mobile information terminal.

9. The central device according to claim 3, comprising an identification information storing unit storing identification information of a user, wherein
said transmission unit transmits to the outside, when identification information is transmitted from said mobile information terminal, open information obtained as a result of conversion by said conversion unit if the transmitted identification information is not found in said identification information storing unit and if a distance between positions based on positional information of said mobile information terminal received by said reception unit and positional information of said mobile information terminal at a time point where said open information is transmitted is equal to or more than the threshold distance stored in the storage unit.

10. The central device according to claim 4, further comprising:
a calculating unit calculating transmission frequency based on transmission time of a plurality of pieces of open information stored in said date-and-time storing unit;
a homebase storing unit storing homebase positional information on a user of said mobile information terminal in a storage unit; and
a shortening unit shortening the threshold distance or the threshold time stored in said storage unit when the transmission frequency calculated by said calculating unit is equal to or more than the threshold frequency stored in the storage unit and when a distance between positions based on the positional information received by said reception unit and the homebase positional information stored in said homebase storing unit is equal to or more than the threshold value stored in the storage unit.

11. The central device according to claim 4, further comprising an increasing unit increasing the threshold time stored in said storage unit when it is judged that a given period of time has elapsed since positional information transmitted from said mobile information terminal is last received by said reception unit.

12. The central device according to claim 4, further comprising:
a positional history storing unit storing positional information received by said reception unit in a positional history database;
a speed calculating unit calculating moving speed based on the positional information stored in said positional history database; and
a shortening unit shortening the threshold distance or threshold time stored in said storage unit when the moving speed calculated by the moving speed calculating unit is equal to or more than threshold moving speed stored in said storage unit.

13. The central device according to claim 3, wherein said conversion unit includes
an extraction unit extracting a plurality of words indicating locations included in the open information transmitted from said mobile information terminal, with reference to the location database in which words indicating locations are classified in accordance with a plurality of classes,
a classification unit classifying the words extracted by the extraction unit into classes, and
a word conversion unit converting a word other than a word belonging to a highest class of the classes classified by the classification unit into said word belonging to the highest class with reference to said location database.

14. The central device according to claim 4, wherein said time conversion unit includes
an extraction unit extracting a plurality of words indicating time included in the open information transmitted from said mobile information terminal, with reference to the time database in which words indicating time are classified in accordance with a plurality of classes,
a classification unit classifying the words extracted by the extraction unit into classes, and
a word conversion unit converting a word other than a word belonging to a highest class of the classes classified by the classification unit into said word belonging to the highest class with reference to said time database.

15. The central device according to claim 3, further comprising:
an auxiliary conversion unit converting a word indicating a location included in the open information transmitted from said mobile information terminal into a word indicating a location belonging to a class higher than a class of the word to be converted by said conversion unit, with reference to a location database in which words indicating locations are classified in accordance with a plurality of classes; and
an auxiliary transmission unit transmitting open information obtained after conversion by said auxiliary conversion unit to the outside, when a distance between positions based on positional information of said mobile information terminal received by said reception unit and positional information of said mobile information terminal at a time point where said open information is transmitted is less than a threshold distance stored in a storage unit.

16. The central device according to claim 4, further comprising:
an auxiliary time conversion unit converting a word indicating time included in the open information transmitted from said mobile information terminal into a word indicating time belonging to a class higher than a class of the word to be converted by said time conversion unit with reference to a time database in which words indicating time are classified in accordance with a plurality of classes; and
an auxiliary transmission unit transmitting to the outside open information obtained after conversion by said auxiliary time conversion unit, when a difference between time output by a clock unit and transmission time stored in said date-and-time storing unit is smaller than the threshold time stored in said storage unit.

17. A central device transmitting to the outside open information transmitted from a mobile information terminal to be released to a third party, comprising:
a date-and-time storing unit storing transmission date and time at which said open information is transmitted by said mobile information terminal;
a time conversion unit converting a word indicating time included in the open information transmitted from said mobile information terminal into a word indicating time belonging to a higher class with reference to a time database in which words indicating time are classified in accordance with a plurality of classes; and
a transmission unit transmitting to the outside open information obtained after conversion by said conversion unit, when a difference between time output by a clock unit and transmission time stored in said date-and-time storing unit is more than threshold time stored in a storage unit.

18. A recording medium in which a program for transmitting from a computer to the outside open information transmitted from a mobile information terminal to the computer so as to be released to a third party, wherein said program including
receiving positional information transmitted from said mobile information terminal,
converting a word indicating a location included in the open information transmitted from said mobile information terminal into a word indicating a location belonging to a higher class, with reference to a location database in which words indicating locations are classified in accordance with a plurality of classes, and
transmitting to the outside open information obtained after conversion when a distance between positions based on the received positional information of said mobile information terminal and positional information of said mobile information terminal at a time point where said open information is transmitted is equal to or more than a threshold distance stored in a storage unit.
